(19) United States
(12) Patent Application Publication
(10) Pub. No.: US 2026/0291617 A1
(43) Pub. Date: Sep. 24, 2026

(54) Split-Bus Polarization Interleaving Transmitter

(71) Applicant: Ayar Labs, Inc., San Jose, CA (US)

(72) Inventor: Sidney Buchbinder, Berkeley, CA (US)

(21) Appl. No.: 19/082,687

(22) Filed: Mar. 18, 2025

(51) Int. Cl. H04B 10/572; G02B 6/293; H04B 10/50

(52) U.S. Cl. CPC H04B 10/572; H04B 10/503; G02B 6/29343

(57) ABSTRACT

An optical data transmitter includes a first set of ring modulators coupled to a first bus waveguide to generate a first set of modulated optical signals within the first bus waveguide. The transmitter includes a second set of ring modulators coupled to a second bus waveguide to generate a second set of modulated optical signals within the second bus waveguide. The transmitter includes a polarization interleaving device that rotates a polarization of the first set of modulated optical signals from the first bus waveguide to a first polarization state to form a first set of output signals. The polarization interleaving device also rotates a polarization of the second set of modulated optical from the second bus waveguide to a second polarization state (opposite of the first polarization state) to form a second set of output signals. The first and second sets of output signals are combined onto an output.

### BACKGROUND OF THE INVENTION

Optical data communication systems operate by modulating laser light to encode digital data patterns within optical signals. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits. In some embodiments, a photodiode is used to detect light of an optical data signal and convert the detected light into a photocurrent that can be processed through electrical circuitry to demodulate the optical data signal to obtain the original digital data pattern from the optical data signal. It is within this context that the present invention arises.

### SUMMARY OF THE INVENTION

In an example embodiment, a transmitter for an optical data communication system is disclosed. The transmitter includes a first bus waveguide. The transmitter also includes a first set of wavelength-selective ring modulators positioned along the first bus waveguide and within an evanescent optical coupling distance of the first bus waveguide. The first set of wavelength-selective ring modulators are configured to modulate optical signals conveyed through the first bus waveguide to generate a first set of modulated optical signals within the first bus waveguide. The transmitter also includes a second bus waveguide. The transmitter also includes a second set of wavelength-selective ring modulators positioned along the second bus waveguide and within an evanescent optical coupling distance of the second bus waveguide. The second set of wavelength-selective ring modulators are configured to modulate optical signals conveyed through the second bus waveguide to generate a second set of modulated optical signals within the second bus waveguide. The transmitter also includes a polarization interleaving device that has a first input optically connected to the first bus waveguide and a second input optically connected to the second bus waveguide. The polarization interleaving device is configured to rotate a polarization of the first set of modulated optical signals received at the first input to a first polarization state to form a first set of output signals. The polarization interleaving device is configured to rotate a polarization of the second set of modulated optical signals received at the second input to a second polarization state to form a second set of output signals. The second polarization state is orthogonal to the first polarization state. The polarization interleaving device is configured to combine the first set of output signals and the second set of output signals onto an output of the transmitter.

In an example embodiment, a method is disclosed for operating a transmitter within an optical data communication system. The method includes receiving a first set of wavelengths of continuous wave laser light on a first bus waveguide. The method also includes conveying the first set of wavelengths of continuous wave laser light through the first bus waveguide past a first set of wavelength-selective ring modulators positioned along the first bus waveguide and within an evanescent optical coupling distance of the first bus waveguide. The method also includes operating the first set of wavelength-selective ring modulators to respectively modulate the first set of wavelengths of continuous wave laser light to generate a first set of modulated optical signals having the first set of wavelengths. The method also includes conveying the first set of modulated optical signals having the first set of wavelengths to a first input of a polarization interleaving device. The method also includes receiving a second set of wavelengths of continuous wave laser light on a second bus waveguide. The method also includes conveying the second set of wavelengths of continuous wave laser light through the second bus waveguide past a second set of wavelength-selective ring modulators positioned along the second bus waveguide and within an evanescent optical coupling distance of the second bus waveguide. The method also includes operating the second set of wavelength-selective ring modulators to respectively modulate the second set of wavelengths of continuous wave laser light to generate a second set of modulated optical signals having the second set of wavelengths. The method also includes conveying the second set of modulated optical signals having the second set of wavelengths to a second input of the polarization interleaving device. The method also includes operating the polarization interleaving device to rotate a polarization of the first set of modulated optical signals received at the first input of the polarization interleaving device to a first polarization state to form a first set of output signals. The method also includes operating the polarization interleaving device to rotate a polarization of the second set of modulated optical signals received at the second input of the polarization interleaving device to a second polarization state to form a second set of output signals. The second polarization state is orthogonal to the first polarization state. The method also includes combining the first set of output signals and the second set of output signals onto a same output.

### BRIEF DESCRIPTION OF THE DRAWINGS

FIG. 1 shows a diagram of the split-bus transmitter (TX), in accordance with some embodiments.

FIG. 2 shows a diagram of a single-bus transmitter (TX), in accordance with some embodiments.

FIG. 3A shows a diagram of the split-bus transmitter (TX) implemented within an optical data communication link, in accordance with some embodiments.

FIG. 3B shows an optical data communication link that has an integrated optical supply (integrated laser), in accordance with some embodiments.

FIG. 4A shows a diagram of the split-bus transmitter (TX) in which the polarization interleaving device is implemented as a polarization splitter rotator (PSR), in accordance with some embodiments.

FIG. 4B shows a diagram of the split-bus transmitter (TX) of FIG. 4A in which the first bus waveguide and the second bus waveguide are lengthened prior to connecting with the PSR, in accordance with some embodiments.

FIG. 4C shows a diagram of the split-bus transmitter (TX) in which the polarization interleaving device is implemented as a dual-polarization grating coupler (DPGC), in accordance with some embodiments.

FIG. 5A shows a diagram of the split-bus transmitter (TX) in which the first set of wavelength-selective ring modulators and the second set of wavelength-selective ring modulators are arranged in a substantially linear manner (in-line), such that all of the ring modulators are positioned in a single row within the split-bus transmitter (TX), in accordance with some embodiments.

FIG. 5B shows a diagram of the split-bus transmitter (TX) of FIG. 5A in which electrical drivers are disposed on a back side of the first set of wavelength-selective ring modulators and the second set of wavelength-selective ring modulators, respectively, in accordance with some embodiments.

FIG. 5C shows a diagram of the split-bus transmitter (TX) in which the first set of wavelength-selective ring modulators and the second set of wavelength-selective ring modulators are arranged in the in-line manner, and in which the first bus waveguide and the second bus waveguide are configured to avoid crossing each other, in accordance with some embodiments.

FIG. 5D shows a diagram of the split-bus transmitter (TX) in which the first set of wavelength-selective ring modulators and the second set of wavelength-selective ring modulators are arranged in two separate rows, respectively, in accordance with some embodiments.

FIG. 5E shows a variation of the split-bus transmitter (TX) configuration of FIG. 5D, in which respective ones of the first set of wavelength-selective ring modulators and the second set of wavelength-selective ring modulators are positioned in a horizontally staggered manner so as to not be vertically aligned with each other, in accordance with some embodiments.

FIG. 6A shows a portion of an example architecture of a chip implementing the split-bus transmitter (TX), in accordance with some embodiments.

FIG. 6B shows a variation of the example architecture of the chip in which the N wavelengths and corresponding N optical fibers are spatially arranged in the input stage to provide a grouping of N/2 odd-indexed wavelengths and a grouping of N/2 even-indexed wavelengths, such that the optical combining stage is not required, in accordance with some embodiments.

FIG. 7A shows a diagram of the split-bus transmitter (TX) implemented within an optical data communication link that includes a polarization multiplexed receiver (RX) macro, in accordance with some embodiments.

FIG. 7B shows a diagram of the split-bus transmitter (TX) implemented within an optical data communication link that includes a polarization diverse receiver (RX) macro, in accordance with some embodiments.

FIG. 7C shows a diagram of the split-bus transmitter (TX) implemented within an optical data communication link that includes a wavelength de-interleaver as a pre-stage to a pair of polarization diverse receiver (RX) macros, in accordance with some embodiments.

FIG. 8 shows a flowchart of a method for operating a transmitter (the split-bus transmitter (TX)) within an optical data communication system, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

Optical data communication systems operate by modulating laser light to encode digital data patterns within optical signals. In some embodiments, a ring modulator is used to modulate continuous wave laser light to generate the modulated laser light that conveys the encoding of digital data patterns. In some embodiments, the ring modulator is positioned within an evanescent optically coupling distance from a bus optical waveguide and operates to modulate light that is propagating through the bus optical waveguide. The ring modulator and associated optical waveguides are fabricated within an electro-optic chip and/or photonic integrated circuit (PIC). The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits within electro-optic and/or PICs. Implementation and operation of optical data communication systems is dependent upon having reliable and efficient techniques for conveyance of optical signals and/or continuous wave laser light between photonic devices, such as between optical fibers, between optical fibers and electro-optic and/or PICs, between optical fibers and interposers, between optical fibers and optically enabled substrates, and between electro-optic and/or PICs, among others.

Various embodiments are described herein for wavelength division multiplexed (WDM) optical data communication link architectures that implement two distinct physical optical waveguide buses per transmit (TX) macro, where each optical waveguide bus conveys a respective wavelength grouping, and where the wavelength groupings are combined by polarization interleaving at output ends of the two optical waveguide buses. The term “waveguide” as used herein refers to an optical waveguide structure through which light is guided. The term “ring resonator” as used herein refers to a circuitous (ring) shaped optical waveguide structure through which light is guided. The term “ring modulator” as used herein refers to a circuitous (ring) shaped optical waveguide structure through which light is guided and within which a light signal is modulated, such as to encode digital data within the modulated light signal. The term “bus waveguide” as used herein refers to an optical waveguide structure through which light is guided that is positioned next to (within an evanescent optical coupling distance of) another waveguide, such as a ring resonator or ring modulator. In some embodiments, the bus waveguide is configured to convey input light to a ring resonator/modulator and convey transmitted/modulated light away from the ring resonator/modulator. The term “drop waveguide” as used herein refers to an optical waveguide structure through which light is guided that is positioned next to (within an evanescent optical coupling distance of) another waveguide, such as a ring resonator or ring modulator. In some embodiments, the drop waveguide is configured to convey transmitted/modulated light away from a ring resonator/modulator.

Since the bandgap energy of silicon is larger than that of photons at telecom frequencies, optical (light) absorption loss within a silicon waveguide is typically negligible. However, the energy of two telecom/datacom-band photons does exceed the bandgap energy of silicon. When the energy of two photons within the silicon waveguide exceeds the bandgap energy of silicon, two-photon absorption (TPA) can occur within the silicon waveguide, thus incurring corresponding optical loss within the silicon waveguide. The likelihood of two photons being absorbed in the silicon waveguide increases quadratically with the intensity of light propagating though the silicon waveguide. Therefore, TPA in the silicon waveguide is a second order optical absorption effect that becomes more pronounced at higher optical power.

While TPA introduces an additional optical loss term, the absorption of the photons in TPA also frees charge carriers (electrons and holes) by promoting them from bound states in the valence band to the conduction band, which produces a free-carrier plasma that leads to further optical losses that are linear in optical intensity for a fixed plasma density. Because a substantial free-carrier density is produced by TPA, increased free-carrier density generation within the silicon waveguide can be an even more significant contributor to linear optical loss within the silicon waveguide at higher optical powers. The free-carriers (electrons and holes) generated within the silicon waveguide produce high free-carrier absorption (FCA) optical losses. The FCA optical loss is linear with the optical intensity for a given carrier density, with the free-carriers in turn being created by a second-order process, thus being a third-order effect. The optical absorption loss (dI/dz) in the silicon waveguide due to TPA and free-carrier optical absorption is represented in Equation 1, where (I) is the light intensity, (z) is the light propagation distance along the silicon waveguide, (α′) is the linear optical loss coefficient due to free-carriers within the silicon waveguide, (τ) is the free-carrier lifetime within the silicon waveguide, and (β′) is the TPA absorption coefficient.

$$( dI / dz ) = - {α}^{′} \cdot τ \cdot {β}^{′} {I}^{3} . \qquad Equation 1$$

With regard to Equation 1, in order to reduce the third-order optical losses, the coefficient (α′·τ·β′) in front of the cubic term of intensity (I³) needs to be minimized. One way to do this is to reduce the free-carrier lifetime (τ). The free-carrier lifetime (τ) is determined by free-carrier diffusion and the free-carrier recombination rate. There is also a modified free-carrier recombination rate near waveguide boundaries, depending on the surface quality (roughness) and chemistry, which affects the free-carrier lifetime (τ), and is described by a surface recombination velocity coefficient. The free-carrier lifetime (τ) within the silicon waveguide is a key parameter, which can be reduced in various ways. For example, in some embodiments, the silicon waveguide fabrication is adjusted to increase the free-carrier recombination rate in silicon and/or at waveguide interfaces so as to correspondingly reduce the free-carrier lifetime (τ) within the silicon waveguide. In some embodiments, free-carriers are removed from the silicon waveguide by applying an electric field in the region of the silicon waveguide in which the free-carriers are generated. More specifically, an electric field is formed across a core region of the silicon waveguide. This electric field pulls the charged free-carriers (electrons and holes) away from the core region of the silicon waveguide through which the primary optical mode propagates, so that the probability of charged free-carriers causing optical absorption loss within the core region is substantially reduced. This process is known as carrier sweep out and can significantly reduce optical losses that scale with free-carrier concentration, such as the third-order optical absorption losses discussed above with regard to Equation 1. In some embodiments, in order to generate the electric field across the core region of the silicon waveguide for free-carrier sweep out, diodes are formed across/along the silicon waveguide and are operated in reverse bias mode.

It should be understood and appreciated that non-linear optical losses due to TPA and free-carrier absorption are relevant in many types and/or configurations of optical waveguides, including, but not limited to, bus waveguides, drop waveguides, ring resonators, ring modulators, and microring resonators/modulators (such as annular-shaped, disk-shaped, racetrack-shaped, and other similar circuitously shaped resonators/modulators), which are collectively referred to as traveling-wave resonators (TWRs). Also, it should be understood and appreciated that non-linear optical losses are relevant in many types and/or configurations of photonic crystals and other standing wave resonators (SWRs).

As discussed above, at high optical power, TPA within the silicon waveguide becomes more likely, which increases the probability of free-carrier generation within the silicon waveguide. The resulting free-carrier absorption within the silicon waveguide leads to high optical losses within the silicon waveguide. In many applications that require optical coupling from a bus waveguide to a ring resonator or other (e.g., output) waveguide, the optical power in the bus waveguide may be high enough that TPA is a serious problem. In optical data communication systems, a bus waveguide may carry many wavelengths of light, corresponding to different communication channels. The combination of these multiple wavelengths of light corresponds to a high optical power density within the bus waveguide. Therefore, it is of interest to improve optical data communication systems to mitigate the adverse optical losses caused by TPA and free-carrier absorption within silicon waveguides of various photonic components.

In WDM optical transmission systems, a number of challenges and impairments are related to the number of wavelengths propagating together through the bus waveguide of the transmitter. For example, the more wavelengths that propagate together, the higher the total power, and the greater the non-linear absorption due to the combination of TPA and free-carrier absorption. Therefore, it is desirable to minimize either the total power or number of wavelengths propagating together through the transmitter. However, the total power and the number wavelengths propagating together through the transmitter are two of the key parameters that advancements in technology strive to increase in order to achieve the highest data transmission capacity of the optical data communication link.

An architecture is disclosed herein for a “split-bus polarization interleaving” transmitter (TX). For ease of discussion, the term “split-bus transmitter (TX)” will be used hereafter. The split-bus transmitter (TX) enables doubling of the channel-to-channel spacing and halving of the optical power per bus waveguide within the split-bus transmitter (TX), as compared to a conventional single-bus transmitter (TX) architecture. This doubling of the channel-to-channel spacing and halving of the optical power per bus waveguide within the split-bus transmitter (TX) provides for reduction of impairments caused by TPA, free-carrier absorption, optical crosstalk, and/or non-linear interference effects. The split-bus transmitter (TX) architecture is easily compatible with extant polarization control schemes for transmitter (TX) input fibers. In some embodiments, the split-bus transmitter (TX) is compatible with and/or enabled by a polarization diverse receiver (RX) architecture, such as that available in the TeraPHY system produced by Ayar Labs, Inc., among others.

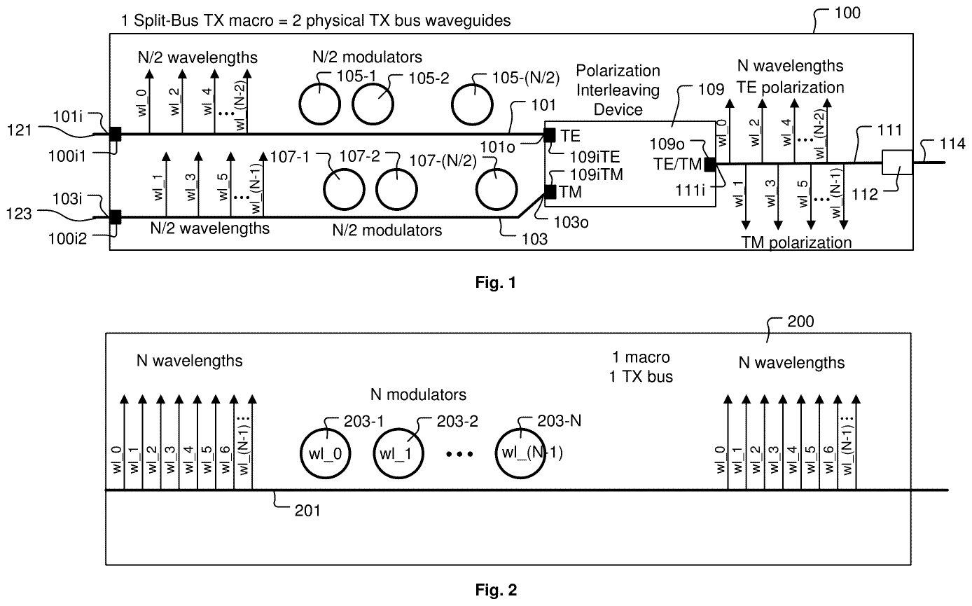

FIG. 1 shows a diagram of the split-bus transmitter (TX) 100, in accordance with some embodiments. Use of the split-bus transmitter (TX) 100 is particularly advantageous in scenarios when it is necessary to strike a balance between number of wavelengths, channel spacing, design complexity, optical power, and total data transmission capacity. The split-bus transmitter (TX) 100 is configured as a photonic electro-optical macro circuit (“macro” hereafter) that includes a first bus waveguide 101 and a second bus waveguide 103. The first bus waveguide 101 and the second bus waveguide 103 are physically distinct waveguides with respect to each other. The first bus waveguide 101 conveys a first group of optical wavelengths (wl_0, wl_2, wl_4, . . . wl_(N−2)), where N is a total number of wavelengths of light conveyed through the split-bus transmitter (TX) 100. The first group of optical wavelengths (wl_0, wl_2, wl_4, . . . wl_(N−2)) is referred to herein as the “even-indexed” group of wavelengths, per the use of even number indexes for the wavelengths. The second bus waveguide 103 conveys a second group of optical wavelengths (wl_1, wl_3, wl_5, . . . wl_(N−1)). The second group of optical wavelengths (wl_1, wl_3, wl_5, . . . wl_(N−1)) is referred to herein as the “odd-indexed” group of wavelengths, per the use of odd number indexes for the wavelengths. The first group of optical wavelengths (wl_0, wl_2, wl_4, . . . wl_(N−2)) and the second group of optical wavelengths (wl_1, wl_3, wl_5, . . . wl_(N−1)) are mutually exclusive with respect to each other. In this manner, a different one of the first bus waveguide 101 and the second bus waveguide 103 is used for conveyance of a different one of the first group of optical wavelengths (wl_0, wl_2, wl_4, . . . wl_(N−2)) and the second group of optical wavelengths (wl_1, wl_3, wl_5, . . . wl_(N−1)). Also, in some embodiments, one-half of the total number (N) of optical wavelengths (i.e., N/2 wavelengths) is included in each of the first group of optical wavelengths (wl_0, wl_2, wl_4, . . . wl_(N−2)) and the second group of optical wavelengths (wl_1, wl_3, wl_5, . . . wl_(N−1)). In some embodiments, the total number (N) of unique optical wavelengths is eight (N=8), with four optical wavelengths wl_0, wl_2, wl_4, and wl_6 on the first bus waveguide 101, and with four optical wavelengths wl_1, wl_3, wl_5, and wl_7 on the second bus waveguide 103. In some embodiments, the total number (N) of unique optical wavelengths is sixteen (N=16), with eight optical wavelengths wl_0, wl_2, wl_4, wl_6, wl_8, wl_10, wl_12, and wl_14 on the first bus waveguide 101, and with eight optical wavelengths wl_1, wl_3, wl_5, wl_7, wl_9, wl_11, wl_13, and wl_15 on the second bus waveguide 103.

In some embodiments, the incoming light signals received by the split-bus transmitter (TX) 100 are arranged in an alternating sequential ordering relative to the first bus waveguide 101 and the second bus waveguide 103, such that the even-indexed wavelengths of the first group of optical wavelengths (wl_0, wl_2, wl_4, . . . wl_(N−2)) are split onto the first bus waveguide 101 in sequential order, and such that the odd-indexed wavelengths of the second group of optical wavelengths (wl_1, wl_3, wl_5, . . . wl_(N−1)) are split onto the second bus waveguide 103 in sequential order. It should be understood, that the mapping of the even-indexed wavelengths and the odd-indexed wavelengths to the first bus waveguide 101 and the second bus waveguide 103, respectively, provides for optimization of system performance. However, in other embodiments, the mapping of the even-indexed wavelengths and the odd-indexed wavelengths to the first bus waveguide 101 and the second bus waveguide 103, respectively, is not required. In some embodiments, the first group of optical wavelengths (wl_0, wl_2, wl_4, . . . wl_(N−2)) and the second group of optical wavelengths (wl_1, wl_3, wl_5, . . . wl_(N−1)) are arranged to maximize a channel-to-channel spacing between two adjacent laser wavelengths on each of the first bus waveguide 101 and the second bus waveguide 103.

The first bus waveguide 101 has an input end 101i optically connected to a first input port 100i1 of the split-bus transmitter (TX) 100. In some embodiments, the optical connection of the first bus waveguide 101 to the first input port 100i1 is configured as a contiguous merging of a first waveguide structure 121 external to the split-bus transmitter (TX) 100 with the first bus waveguide 101. In some embodiments, the optical connection of the first bus waveguide 101 to the first input port 100i1 is configured as an optical connection to an optical coupling device to which the first waveguide structure 121 external to the split-bus transmitter (TX) 100 is optically connected.

Input light signals having the first even-indexed group of optical wavelengths (wl_0, wl_2, wl_4, . . . wl_(N−2)) are transmitted through the input end 101i of the first bus waveguide 101. A first set of wavelength-selective ring modulators 105-1 to 105-(N/2) are positioned along the first bus waveguide 101 and within an evanescent optical coupling distance of the first bus waveguide 101. Each of the first set of wavelength-selective ring modulators 105-1 to 105-(N/2) is tuned to have a resonance wavelength substantially equal to a respective one of the wavelengths within the first group of even-indexed optical wavelengths (wl_0, wl_2, wl_4, . . . wl_(N−2)). In this manner, each ring modulator 105-1 to 105-(N/2) is controlled to in-couple a corresponding one of the optical wavelengths (wl_0, wl_2, wl_4, . . . wl_(N−2)) from the first bus waveguide 101, and out-couple the corresponding one of the optical wavelengths (wl_0, wl_2, wl_4, . . . wl_(N−2)) to the first bus waveguide 101. Each ring modulator 105-1 to 105-(N/2) is operated to modulate light of the corresponding one of the optical wavelengths (wl_0, wl_2, wl_4, . . . wl_(N−2)) to encode digital data patterns within modulated light signals. In some embodiments, each of the ring modulators 105-1 to 105-(N/2) is a microring modulator. In some embodiments, each of the ring modulators 105-1 to 105-(N/2) has a diameter of less than or equal to about 10 micrometers.

The second bus waveguide 103 has an input end 103i optically connected to a second input port 100i2 of the split-bus transmitter (TX) 100. In some embodiments, the optical connection of the second bus waveguide 103 to the second input port 100i2 is configured as a contiguous merging of a second waveguide structure 123 external to the split-bus transmitter (TX) 100 with the second bus waveguide 103. In some embodiments, the optical connection of the second bus waveguide 103 to the second input port 100i2 is configured as an optical connection to an optical coupling device to which the second waveguide structure 123 external to the split-bus transmitter (TX) 100 is optically connected.

Input light signals having the second odd-indexed group of optical wavelengths (wl_1, wl_3, wl_5, . . . wl_(N−1)) are transmitted through the input end 103i of the second bus waveguide 103. A second set of wavelength-selective ring modulators 107-1 to 107-(N/2) are positioned along the second bus waveguide 103 and within an evanescent optical coupling distance of the second bus waveguide 103. Each of the second set of wavelength-selective ring modulators 107-1 to 107-(N/2) is tuned to have a resonance wavelength substantially equal to a respective one of the wavelengths within the second odd-indexed group of optical wavelengths (wl_1, wl_3, wl_5, . . . wl_(N−1)). In this manner, each ring modulator 107-1 to 107-(N/2) is controlled to in-couple a corresponding one of the optical wavelengths (wl_1, wl_3, wl_5, . . . wl_(N−1)) from the second bus waveguide 103, and out-couple the corresponding one of the optical wavelengths (wl_1, wl_3, wl_5, . . . wl_(N−1)) to the second bus waveguide 103. Each ring modulator 107-1 to 107-(N/2) is operated to modulate light of the corresponding one of the optical wavelengths (wl_1, wl_3, wl_5, . . . wl_(N−1)) to encode digital data patterns within modulated light signals. In some embodiments, each of the ring modulators 107-1 to 107-(N/2) is a microring modulator. In some embodiments, each of the ring modulators 107-1 to 107-(N/2) has a diameter of less than or equal to about 10 micrometers.

In some embodiments, the light signals of the first even-indexed group of optical wavelengths (wl_0, wl_2, wl_4, . . . wl_(N−2)) have one of two polarization states (transverse electric (TE) and transverse magnetic (TM)), typically TE, as they are conveyed through the first bus waveguide 101 and modulated (to convey digital data) by a corresponding one of the wavelength-selective ring modulators 105-1 to 105-(N/2). Also, in these embodiments, the light signals of the second odd-indexed group of optical wavelengths (wl_1, wl_3, wl_5, . . . wl_(N−1)) have the same one polarization state as the light signals of the first group of optical wavelengths (wl_0, wl_2, wl_4, . . . wl_(N−2)), typically TE, as they are conveyed through the second bus waveguide 103 and modulated (to convey digital data) by a corresponding one of the wavelength-selective ring modulators 107-1 to 107-(N/2). Therefore, in some embodiments, the light that is conveyed through both the first bus waveguide 101 and the second bus waveguide 103 is of TE polarization. However, in some embodiments, the light that is conveyed through both the first bus waveguide 101 and the second bus waveguide 103 is of TM polarization.

The split-bus transmitter (TX) 100 includes a polarization interleaving device 109 that has a first optical input 109iTE to which an output end 1010 of the first bus waveguide 101 is optically connected. The first optical input 109iTE of the polarization interleaving device 109 is designated as a TE polarization input to indicate that light signals entering the polarization interleaving device 109 through the first optical input 109iTE will have their polarization rotated to TE by the polarization interleaving device 109. Specifically, light signals that enter the polarization interleaving device 109 through the first optical input 109iTE with the TE polarization will retain the TE polarization as they are conveyed through the polarization interleaving device 109. In other situations where TM is the primary optical mode conveyed on the first bus waveguide 101 and the second bus waveguide 103, light signals that enter the polarization interleaving device 109 through the first optical input 109iTE with the TM polarization will have their polarization rotated to the TE polarization as they are conveyed through the polarization interleaving device 109.

The polarization interleaving device 109 also has a second optical input 109iTM to which an output end 1030 of the second bus waveguide 103 is optically connected. The second optical input 109iTM of the polarization interleaving device 109 is designated as a TM polarization input to indicate that light signals entering the polarization interleaving device 109 through the second optical input 109iTM will have their polarization rotated to TM by the polarization interleaving device 109. Specifically, light signals that enter the polarization interleaving device 109 through the second optical input 109iTM with the TE polarization will have their polarization rotated to the TM polarization as they are conveyed through the polarization interleaving device 109. In other situations where TM is the primary optical mode conveyed on the first bus waveguide 101 and the second bus waveguide 103, light signals that enter the polarization interleaving device 109 through the second optical input 109iTM with the TM polarization will retain the TM polarization as they are conveyed through the polarization interleaving device 109.

The polarization interleaving device 109 is also configured to convey the light signals that are received through the first optical input 109iTE, after having been rotated as-needed to the TE polarization, to an output port 1090 of the polarization interleaving device 109. Also, the polarization interleaving device 109 is configured to convey the light signals that are received through the second optical input 109iTM, after having been rotated as-needed to the TM polarization, to the output port 1090 of the polarization interleaving device 109. In this manner, the first even-indexed group of optical wavelengths (wl_0, wl_2, wl_4, . . . wl_(N−2)) of light signals that are conveyed along the first bus waveguide 101, and that are modulated by respective ones of the first set of wavelength-selective ring modulators 105-1 to 105-(N/2), and that are conveyed into the first optical input 109iTE of the polarization interleaving device 109, are conveyed through the output port 1090 of the polarization interleaving device 109 with the TE polarization. Also, the second odd-indexed group of optical wavelengths (wl_1, wl_3, wl_5, . . . wl_(N−1)) of light signals that are conveyed along the second bus waveguide 103, and that are modulated by respective ones of the second set of wavelength-selective ring modulators 107-1 to 107-(N/2), and that are conveyed into the second optical input 109iTM of the polarization interleaving device 109, are conveyed through the output port 1090 of the polarization interleaving device 109 with the TM polarization. In some embodiments, the output port 1090 of the polarization interleaving device 109 is optically connected to an input end 111i of an output waveguide 111 of the split-bus transmitter (TX) 100. In some embodiments, the output waveguide 111 is optically connected to an optical coupler 112, such as edge optical coupler, which is in turn optically connected to a waveguide 114 of the optical data communication system. In some embodiments, the output waveguide 111 is formed in a contiguous manner with the waveguide 114 of the optical data communication system, such that the distinct optical coupler 112 is not required. In some embodiments, the optical waveguide 114 of the external system is directly optically connected to the output port 1090 of the polarization interleaving device 109. In some embodiments, the output of the polarization interleaving device 109 is projected as an output light beam, such that the output waveguide 111 is not implemented. For example, in some embodiments, the output of the polarization interleaving device 109 is projected as an output light beam into the waveguide 114 that is optically connected to the split-bus transmitter (TX) 100, wherein the waveguide 114 is a physical waveguide, an optical fiber, or another optical conveyance device. For ease of discussion, various embodiments of the split-bus transmitter (TX) 100 are disclosed herein as implementing the output waveguide 111 (and, optionally, the optical coupler 112). However, it should be understood that the various embodiments of the split-bus transmitter (TX) 100 disclosed herein are equally implementable without having the output waveguide 111 present, such as by having the system waveguide 114 positioned to receive the light output of the polarization interleaving device 109 (or equivalent device) or by having the output light of the polarization interleaving device 109 (or equivalent device) projected directly into another photonic component.

In accordance with the foregoing, it should understood that the polarization interleaving device 109 is disposed at the ends of the first bus waveguide 101 and the second bus waveguide 103 relative to the light propagation direction, such that the first even-indexed group of optical wavelengths (wl_0, wl_2, wl_4, . . . wl_(N−2)) of light signals and the second odd-indexed group of optical wavelengths (wl_1, wl_3, wl_5, . . . wl_(N−1)) of light signals are combined into the single output waveguide 111 of the split-bus transmitter (TX) 100, and such that the first even-indexed group of optical wavelengths (wl_0, wl_2, wl_4, . . . wl_(N−2)) of light signals and the second odd-indexed group of optical wavelengths (wl_1, wl_3, wl_5, . . . wl_(N−1)) of light signals have orthogonal polarization optical modes on the single output waveguide 111 of the split-bus transmitter (TX) 100.

The mapping of a specific ring modulator within each of the first set of wavelength-selective ring modulators 105-1 to 105-(N/2) and the second set of wavelength-selective ring modulators 107-1 to 107-(N/2) to a specific wavelength depends on the particular implementation of the split-bus transmitter (TX) 100. In some embodiments, the mapping of a specific ring modulator to a specific wavelength is done in an arbitrary manner. However, in some embodiments, the mapping of a specific ring modulator to a specific wavelength is done through thermal and/or electrical tuning in order to pair up specific ring modulators with specific laser wavelengths. In some embodiments in which the first set of wavelength-selective ring modulators 105-1 to 105-(N/2) and the second set of wavelength-selective ring modulators 107-1 to 107-(N/2) are implemented as microring modulators, circuitry is implemented to control the resonance wavelengths of the microring modulators, such that each of the microring resonators is controllable to operate at a particular one of multiple wavelengths to enable a functional transceiver system.

Typically, the first set of wavelength-selective ring modulators 105-1 to 105-(N/2) will act on the first even-indexed group of optical wavelengths (wl_0, wl_2, wl_4, . . . wl_(N−2)) in the TE polarization mode as conveyed through the first bus waveguide 101. Also, typically, the second set of wavelength-selective ring modulators 107-1 to 107-(N/2) will act on the second odd-indexed group of optical wavelengths (wl_1, wl_3, wl_5, . . . wl_(N−1)) in the TE polarization mode as conveyed through the second bus waveguide 103. Therefore, the polarization interleaving device 109 typically takes two TE polarization inputs from different waveguides 101 and 103 and converts them to orthogonal optical polarizations at the optical output 1090 of the polarization interleaving device 109, and conveys them through the single physical output waveguide 111. The polarization interleaving device 109 is configured to have low optical loss and broad optical bandwidth, as determined by the application of the split-bus transmitter (TX) 100.

In some implementations, the polarization interleaving device 109 is implemented with a polarization splitter rotator (PSR) such that the output of the first bus waveguide 101 and the output of the second bus waveguide 103 are respectively fed into the separate TE and TM optical waveguides of the PSR, with the combined N-wavelength TE/TM output waveguide 111 carrying all N wavelengths, with the first even-indexed group of optical wavelength (wl_0, wl_2, wl_4, . . . wl_(N−2)) signals in the TE optical mode, and with the first odd-indexed group of optical wavelength (wl_1, wl_3, wl_5, . . . wl_(N−1)) signals in the TM optical mode.

In various embodiments, the physical implementation of the various optical waveguides of the split-bus transmitter (TX) 100 (the first bus waveguide 101, the second bus waveguide 103, the first set of wavelength-selective ring modulators 105-1 to 105-(N/2), the second set of wavelength-selective ring modulators 107-1 to 107-(N/2), the polarization interleaving device 109, and the output optical waveguide 111) can be as one or more of a silicon waveguide, a non-linear mitigated silicon waveguide, a rib waveguide, a ridge waveguide, and a silicon nitride waveguide, or another waveguide implementation, or a mixture of waveguide implementations, as best suited for use in the photonic process to achieve low optical propagation loss and required optical coupling to the ring modulators 105-1 to 105-(N/2) and 107-1 to 107-(N/2), and proper optical modulation within the ring modulators 105-1 to 105-(N/2) and 107-1 to 107-(N/2).

To better appreciate the advantages afforded by the split-bus transmitter (TX) 100, it is helpful to make reference to a single-bus transmitter (TX). FIG. 2 shows a diagram of a single-bus transmitter (TX) 200, in accordance with some embodiments. The single-bus transmitter (TX) 200 includes a single bus waveguide 201. Input light signals having a number (N) of optical wavelengths (wl_0, wl_1, wl_2, . . . wl_(N−1)) are transmitted through the single bus waveguide 201. A set of N wavelength-selective ring modulators 203-1 to 203-N are positioned along the single bus waveguide 201 and within an evanescent optical coupling distance of the single bus waveguide 201. Each of the N wavelength-selective ring modulators 203-1 to 203-N is tuned to have a resonance wavelength substantially equal to a respective one of the N optical wavelengths (wl_0, wl_1, wl_2 . . . wl_(N−1)) of light conveyed through the single bus waveguide 201. In this manner, each ring modulator 203-1 to 203-N is controlled to in-couple a corresponding one of the optical wavelengths (wl_0, wl_1, wl_2, . . . wl_(N−1)) from the single bus waveguide 201, and out-couple the corresponding one of the optical wavelengths (wl_0, wl_1, wl_2, . . . wl_(N−1)) to the single bus waveguide 201. Each ring modulator 203-1 to 203-N is operated to modulate light of the corresponding one of the optical wavelengths (wl_0, wl_1, wl_2, . . . wl_(N−1)) to encode digital data patterns within modulated light signals. In this manner, all of the modulated light signals for all of the optical data communication channel wavelengths (wl_0, wl_1, wl_2, . . . wl_(N−1)) are conveyed through the same single bus waveguide 201. Also, all of the modulated light signals for all of the optical data communication channel wavelengths (wl_0, wl_1, wl_2, . . . wl_(N−1)) have the same polarization state within the same single bus waveguide 201. In the example split-bus transmitter (TX) 100 embodiment of FIG. 1, exactly half of the total number (N) of modulators are in the first set of wavelength-selective ring modulators 105-1 to 105-(N/2), and exactly half of the total number (N) of modulators are in the second set of wavelength-selective ring modulators 107-1 to 107-(N/2). This particular embodiment beneficially provides a full two-fold reduction in optical power in each of the first bus waveguide 101 and the second bus waveguide 103 as compared with the single-bus transmitter (TX) 200, assuming all channels have equal input optical power. However, it should be understood that in other embodiments the number of wavelengths within each of the first bus waveguide 101 and the second bus waveguide 103 can be unequal. Specifically, in some embodiments, the first bus waveguide conveys (x) wavelengths, and the second bus waveguide 103 conveys (y) wavelengths, where (y) is not equal to (x).

In comparison with the single-bus transmitter (TX) 200, by having one-half of the N optical wavelengths on each of the first bus waveguide 101 and the second bus waveguide 103, the split-bus transmitter (TX) 100 provides increased channel-to-channel spacing on each of the first bus waveguide 101 and the second bus waveguide 103, which helps avoid channel crosstalk within the split-bus transmitter (TX) 100 macro. Also, by having one-half of the N optical wavelengths on each of the first bus waveguide 101 and the second bus waveguide 103, the split-bus transmitter (TX) 100 provides decreased optical power on each of the first bus waveguide 101 and the second bus waveguide 103, which helps avoid non-linear optical losses, such as caused by TPA and free-carrier generation. Also, by having one-half of the N optical wavelengths on each of the first bus waveguide 101 and the second bus waveguide 103, the split-bus transmitter (TX) 100 provides decreased optical power on each of the first bus waveguide 101 and the second bus waveguide 103, which helps avoid four-wave mixing (FWM) problems.

The output of the single-bus transmitter (TX) 200 has two guided polarization modes, even if both polarization modes are not used to carry output signals. With the split-bus transmitter (TX) 100, wavelengths of the first even-indexed group (wl_0, wl_2, wl_4, . . . wl_(N−2)) are output in a first polarization state, and wavelengths of the second odd-indexed group (wl_1, wl_3, wl_5, . . . wl_(N−1)) are output in a second polarization state that is orthogonal to the first polarization state.

Additionally, since the optical power is generally substantially less after modulation, having the two separate bus waveguides 101 and 103 within the split-bus transmitter (TX) 100 reduces the co-propagation of high-power light within a given bus waveguide, which reduces non-linear optical loss or other adverse optical interactions. Having decreased optical power in each of the first bus waveguide 101 and the second bus waveguide 103, and in the subsequent output waveguide 111, reduces a need to tailor other design decisions to address non-linear optical impairments and adverse optical interactions. For example, the decreased optical power per waveguide, as afforded by the split-bus transmitter (TX) 100, provides for less constrained selection of waveguide type, which assists with reduction of total optical loss. For example, in some embodiments, with sufficiently low optical power per waveguide, silicon is used to form the first bus waveguide 101, the second bus waveguide 103, and the output waveguide 111. In another example, if the input optical power is increased, a combination of silicon and nitride sections is used to implement the split-bus transmitter (TX) 100, e.g., the first bus waveguide 101 and the second bus waveguide 103 are formed of silicon, and the output waveguide 111 is formed of nitride.

In some embodiments, the first set of wavelength-selective ring modulators 105-1 to 105-(N/2) and the second set of wavelength-selective ring modulators 107-1 to 107-(N/2) require a larger channel spacing than what is needed on the output waveguide 111. In some embodiments, the effective channel spacing from the point of view of total data communication signal capacity is substantially less than the channel spacing present in each of the first bus waveguide 101 and the second bus waveguide 103. This allows the effective channel spacing of the overall split-bus transmitter (TX) 100 to be narrower (leading to better spectral efficiency) than the minimum channel spacing allowed by the first set of wavelength-selective ring modulators 105-1 to 105-(N/2) and the second set of wavelength-selective ring modulators 107-1 to 107-(N/2). As a result, in some optical data communication link architectures, the split-bus transmitter (TX) 100 is pairable with higher-order receiver (RX) filters that are capable of handling narrower channel spacing.

To further illustrate the advantages of the split-bus transmitter (TX) 100, consider an application in which a total of N input wavelengths are needed to achieve a desired total data transmission capacity, and where the available laser source has nominal channel wavelength spacing of DELTA_WL between each adjacent wavelength (such that the total span of the input wavelengths is equal to the product of DELTA_WL and (N−1), i.e., Total Wavelength Span=[(N−1)*DELTA_WL]. Also, consider that each wavelength input into the split-bus transmitter (TX) 100 has an optical power of P_CHANNEL. In a WDM architecture that implements the single-bus transmitter (TX) 200 with microring modulators 203-1 to 203-N, the microring modulators 203-1 to 203-N directly see neighboring wavelengths spaced by DELTA_WL, and the single bus waveguide 201 sees total optical power of (N*P_CHANNEL). In this WDM architecture, any impairment due to high optical power or close wavelength spacing is unmitigated. However, in comparison, with the split-bus transmitter (TX) 100, the channel spacing between adjacent optical channels on each of the first bus waveguide 101 and the second bus waveguide 103 is (2*DELTA_WL), and the total optical power on each of the first bus waveguide 101 and the second bus waveguide 103 is (0.5*N*P_CHANNEL). Therefore, it should be appreciated that the split-bus transmitter (TX) 100 provides for double the channel spacing and one-half of the total optical power per each of the first bus waveguide 101 and the second bus waveguide 103, and in the region where wavelengths are most highly interacting and most prone to impairments. Also, in the split-bus transmitter (TX) 100, the total optical power is split nominally equally between two distinct spatial waveguides (101 and 103) initially, and then into two orthogonal polarization modes (TE and TM) (by the polarization interleaving device 109), which reduces the impact of non-linear impairments in the signals conveyed through the split-bus transmitter (TX) 100. Also, the channel spacing between adjacent channels of a particular polarization on the output waveguide 111 of the split-bus transmitter (TX) 100 is double the channel spacing on the bus waveguide 201 of the single-bus transmitter (TX) 200. The total optical power, wavelength spacing between adjacent channels, and number of wavelengths on the output waveguide 111 of the split-bus transmitter (TX) 100 are nominally the same as on the output of the bus waveguide 201 of the single-bus transmitter (TX) 200, which enables substitution of the split-bus transmitter (TX) 100 for the single-bus transmitter (TX) 200 in most applications.

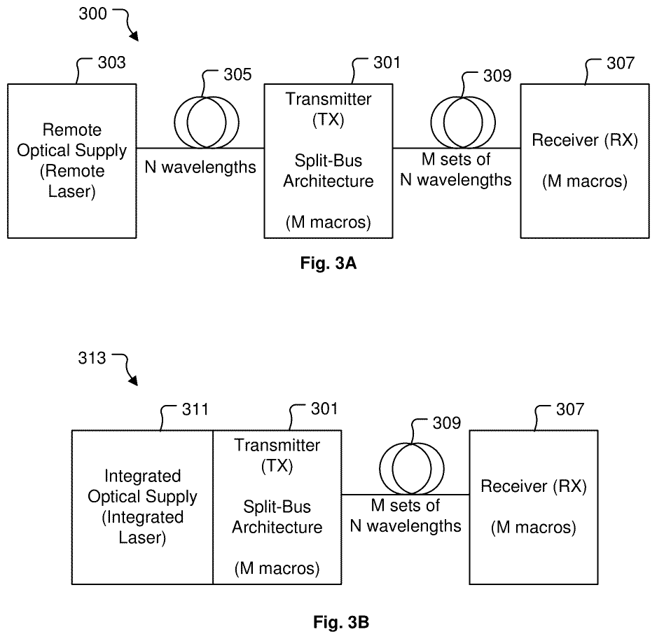

FIG. 3A shows a diagram of the split-bus transmitter (TX) 100 implemented within an optical data communication link 300, in accordance with some embodiments. The optical data communication link 300 includes a transmitter (TX) 301 that includes a non-zero integer number (M) of split-bus transmitter (TX) 100 macros, such as shown in FIG. 1. The transmitter (TX) 301 is optically connected to receive N wavelengths of continuous wave laser light from a remote optical supply 303, e.g., remote laser, by way of optical fibers 305. Each of the M split-bus transmitter (TX) 100 macros is operated to modulate the N wavelengths of continuous wave laser light to generate N modulated light signals that convey encoded digital data. The M split-bus transmitter (TX) 100 macros within the transmitter (TX) 301 cumulatively generate M sets of N modulated light signals, which are conveyed to a receiver (RX) 307, by way of optical fibers 309. The receiver (RX) 307 includes M receiver macros, where each of the M receiver macros is configured to de-modulate the N modulated light signals in a given one of the M sets to transfer the encoded digital data from the optical domain to the electrical domain.

In the example optical data communication link 300 of FIG. 3A, the remote optical supply 303 (remote laser) is physically separate from the transmitter (TX) 301, such that the optical fibers 305 are required to convey the continuous wave laser light from the remote optical supply 303 to the transmitter (TX) 301 for use as input light. This allows for separate fabrication and maintenance of the remote optical supply 303 relative to the transmitter (TX) 301. However, in some embodiments, the optical power supply is integrated within the transmitter (TX) 301. For example, FIG. 3B shows an optical data communication link 313 that has an integrated optical supply 311 (integrated laser), in accordance with some embodiments. In some embodiments, the integrated optical supply 311 is implemented with a same chip as the transmitter (TX) 301, such that the continuous wave laser light generated by the optical supply 311 is transmitted through on-chip optical waveguides to the transmitter (TX) 301. In some embodiments, the integrated optical supply 311 is implemented with a same multi-chip package as the transmitter (TX) 301, such that the continuous wave laser light generated by the optical supply 311 is transmitted through an interposer (or other optical conveyance device) to the transmitter (TX) 301. In the example embodiment of FIG. 3B, the receiver (RX) 307 receives the modulated light signals from the transmitter (TX) 301, by way of the optical fibers 309, and operates in the same manner as described with regard to FIG. 3A. It should be appreciated that the split-bus transmitter (TX) 100 disclosed herein is not limited to use within the optical data communication links 300 and 313. The split-bus transmitter (TX) 100 disclosed herein can be implemented in essentially any optical/photonic architecture in which digital data is encoded within modulated optical data signals.

In some embodiments, each of the optical data communication links 300 and 313 is a WDM link in which each optical fiber 309 carries signals on N wavelengths from a paired split-bus transmitter (TX) 100 macro (such as shown in FIG. 1) to a paired received (RX) macro. In some embodiments, each of the transmitter (TX) 301 chip and the receiver (RX) 307 chip includes M macros, where the number M of macros is defined independent of the number N of wavelengths. In various embodiments, the number M of macros (in each of the transmitter (TX) 301 and receiver (RX) 307) is either different than or equal to the number N of wavelengths. In some embodiments, the transmitter (TX) 301 is a monolithic integrated circuit chip that includes both electronics and photonics. In some embodiments, the transmitter (TX) 301 includes a photonic integrated circuit (PIC) and an electronic integrated circuit (EIC). In some embodiments, the transmitter (TX) 301 and the receiver (RX) 307 are implemented together within a common device called a transceiver (TX/RX). In some embodiments, the transmitter (TX) 301 and the receiver (RX) 307 are optically connected together within the transceiver (TX/RX) through solid waveguide structures instead of through the optical fibers 309. In some embodiments, the transceiver (TX/RX) is connected to the optical communication network through duplex links.

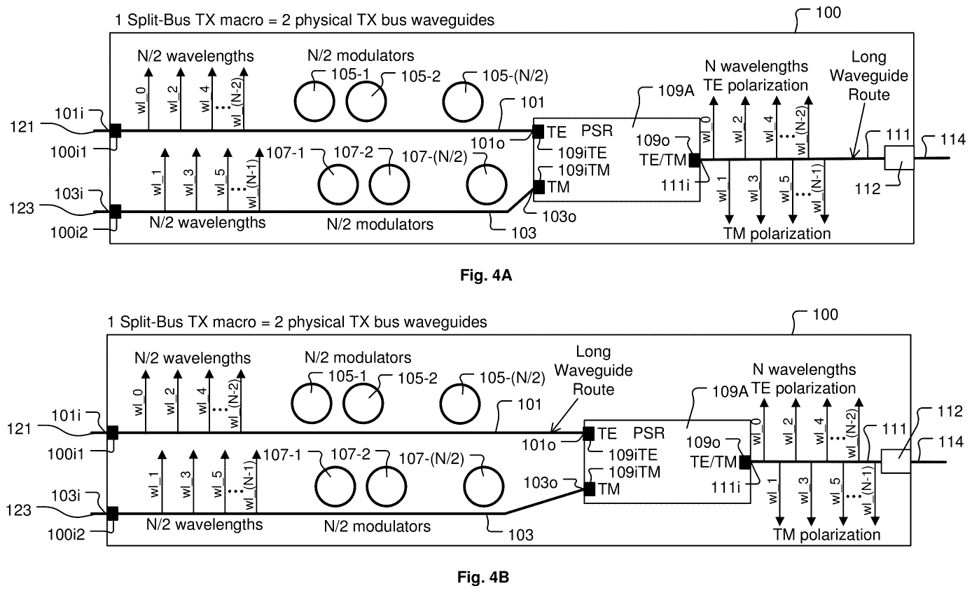

FIG. 4A shows a diagram of the split-bus transmitter (TX) 100 in which the polarization interleaving device 109 is implemented as a polarization splitter rotator (PSR) 109A, in accordance with some embodiments. The PSR 109A operates such that the output of the first bus waveguide 101 and the output of the second bus waveguide 103 are respectively fed into the separate TE and TM optical waveguides of the PSR, with the combined N-wavelength TE/TM output waveguide 111 carrying all N wavelengths, with the first even-indexed group of optical wavelength (wl_0, wl_2, wl_4, . . . wl_(N−2)) signals in the TE optical mode, and with the first odd-indexed group of optical wavelength (wl_1, wl_3, wl_5, . . . wl_(N−1)) signals in the TM optical mode. In various embodiments, the PSR 109A is configured to have low optical insertion loss, low polarization dependent loss (PDL), broadband operability, and low differential group delay. In some embodiments, the PSR 109A has a worse-case insertion loss equal to or better than-0.5 dB, a PDL equal to or lower than 0.1 dB, an optical bandwidth equal to or greater than 30 nanometers, and a differential group delay equal to or lower than 0.2 picoseconds. In some embodiments, such as shown in FIG. 4A, the PSR 109A is placed physically close to an end of the modulator section of the split-bus transmitter (TX) 100 that includes the first set of wavelength-selective ring modulators 105-1 to 105-(N/2) and the second set of wavelength-selective ring modulators 107-1 to 107-(N/2), such that the optical signals conveyed on first bus waveguide 101 and the second bus waveguide 103 are combined onto one physical waveguide early in the optical train. For example, in some embodiments, this positioning of the PSR 109A closer to the modulator section of the split-bus transmitter (TX) 100 is done to save waveguide routing space.

FIG. 4B shows a diagram of the split-bus transmitter (TX) 100 of FIG. 4A in which the first bus waveguide 101 and the second bus waveguide 103 are lengthened prior to connecting with the PSR 109A, in accordance with some embodiments. In some implementations, the PSR 109A is positioned physically close to the output optical coupler 112 of the split-bus transmitter (TX) 100. In some embodiments, the output optical coupler 112 is an edge coupler that supports dual polarizations. For example, in some embodiments, the PSR 109A is positioned physically close to the output optical coupler 112 to maximize the distance of waveguide routing during which the optical power is halved by way of the combination of the first bus waveguide 101 and the second bus waveguide 103.

FIG. 4C shows a diagram of the split-bus transmitter (TX) 100 in which the polarization interleaving device 109 is implemented as a dual-polarization grating coupler (DPGC) 109B, in accordance with some embodiments. The DPGC 109B is configured to perform the polarization interleaving such that signals from the first bus waveguide 101 that are input to the DPGC 109B are coupled into a first optical fiber mode, and such that signals from the second bus waveguide 103 that are input to the DPGC 109B are coupled into a second optical fiber mode, where the second optical fiber mode is orthogonal to the first optical fiber mode, e.g., the first optical fiber mode is TE and the second optical fiber mode is TM, or the first optical fiber mode is TM and the second optical fiber mode is TE. The DPGC 109B operates to convey both the signals from the first bus waveguide 101 in the first optical fiber mode and the signals from the second bus waveguide 103 in the second optical fiber mode through a same output. In some embodiments, the output of the DPGC 109B is optically inserted into the optical waveguide 114 of the external system. In some embodiments, the output of the DPGC 109B is conveyed as a light beam that is projected into an optical conveyance device, such as an optical waveguide or an optical fiber.

It should be understood that polarization interleaving device 109 can be implemented in many ways that provide for: 1) transmission of optical signals from the first bus waveguide 101 onto the output waveguide 111 with a first polarization state, and 2) transmission of optical signals from the second bus waveguide 103 onto the output waveguide 111 with a second polarization state that is orthogonal to the first polarization state. In some embodiments, the first polarization state is TE, and the second polarization state is TM. In some embodiments, the first polarization state is TM, and the second polarization state is TE. In some embodiments, the polarization interleaving device 109 is implemented as a fiber-to-chip coupling device that takes the first bus waveguide 101 output into a first polarization of a fiber mode, and that takes the second bus waveguide 103 output into a second polarization of the same fiber mode, where first polarization and the second polarization are orthogonal to each other.

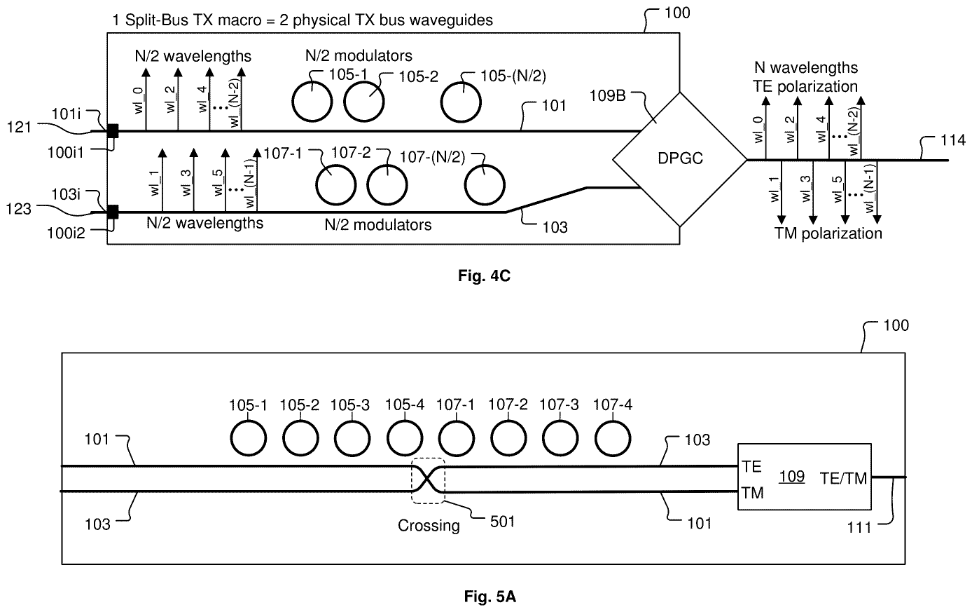

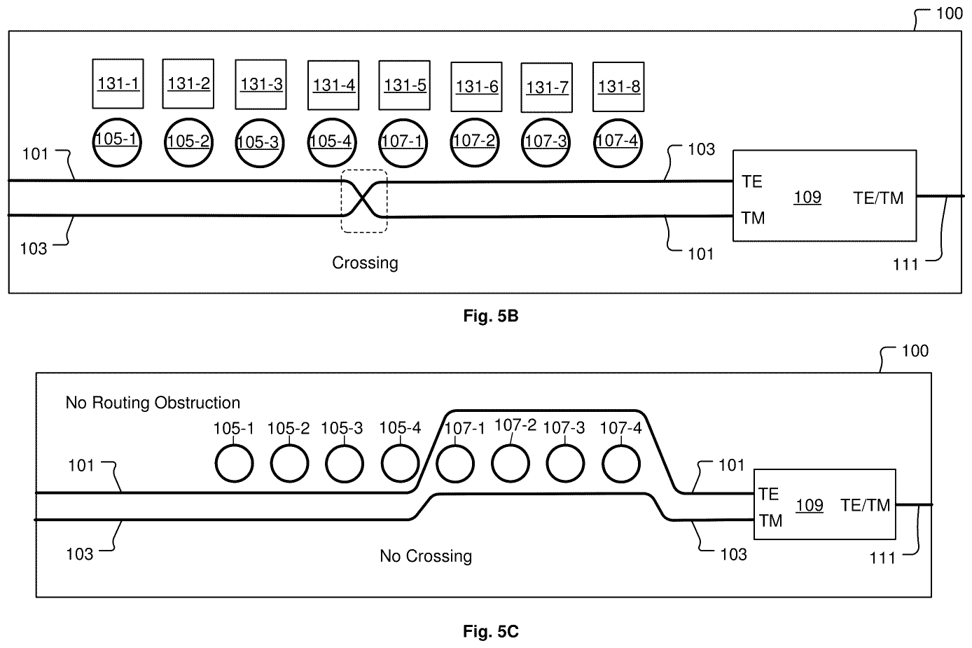

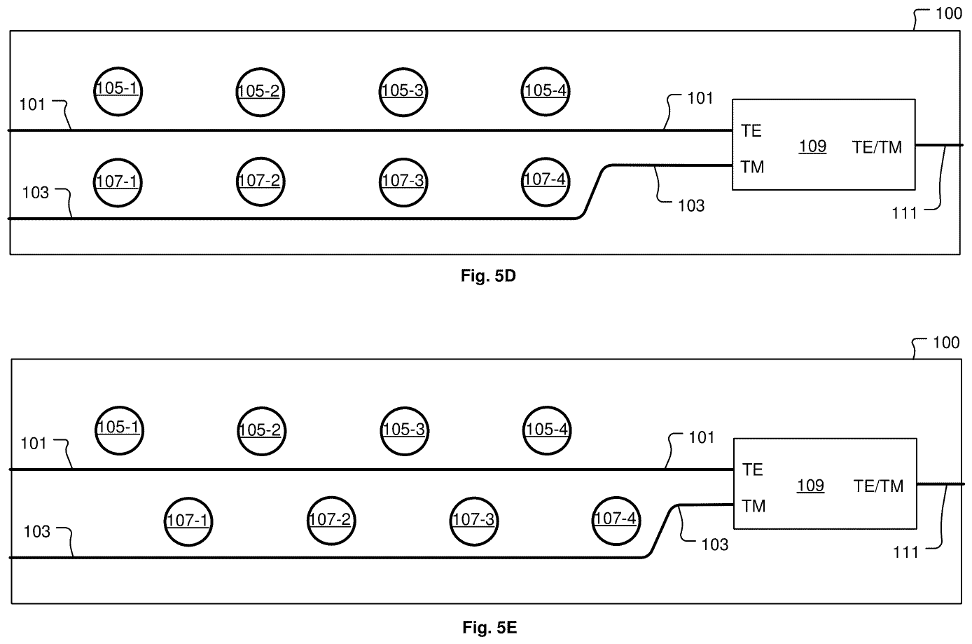

In various embodiments, the split-bus transmitter (TX) 100 is implemented with various physical layouts to accommodate chip floor-planning and/or routing constraints. FIG. 5A shows a diagram of the split-bus transmitter (TX) 100 in which the first set of wavelength-selective ring modulators 105-1 to 105-(N/2) and the second set of wavelength-selective ring modulators 107-1 to 107-(N/2) are arranged in a substantially linear manner (in-line), such that all of the ring modulators 105-1 to 105-(N/2) and 107-1 to 107-(N/2) are positioned in a single row within the split-bus transmitter (TX) 100, in accordance with some embodiments. FIG. 5A also shows implementation of a waveguide crossing structure 501 to enable the first bus waveguide 101 and the second bus waveguide 103 to cross each other to facilitate the in-line arrangement of the ring modulators 105-1 to 105-(N/2) and 107-1 to 107-(N/2). Use of the waveguide crossing structure 501 provides for minimization of optical loss within each of the first bus waveguide 101 and the second bus waveguide 103, and minimization of crosstalk between the first bus waveguide 101 and the second bus waveguide 103.

FIG. 5B shows a diagram of the split-bus transmitter (TX) 100 of FIG. 5A in which electrical drivers 131-1 to 131-8 are disposed on a back side of the first set of wavelength-selective ring modulators 105-1 to 105-(N/2) and the second set of wavelength-selective ring modulators 107-1 to 107-(N/2), respectively, in accordance with some embodiments. The back side of the first set of wavelength-selective ring modulators 105-1 to 105-(N/2) and the second set of wavelength-selective ring modulators 107-1 to 107-(N/2) is opposite of a front side of the first set of wavelength-selective ring modulators 105-1 to 105-(N/2) and the second set of wavelength-selective ring modulators 107-1 to 107-(N/2) along which the first bus waveguide 101 and the second bus waveguide 103 are routed past the first set of wavelength-selective ring modulators 105-1 to 105-(N/2) and the second set of wavelength-selective ring modulators 107-1 to 107-(N/2).

FIG. 5C shows a diagram of the split-bus transmitter (TX) 100 in which the first set of wavelength-selective ring modulators 105-1 to 105-(N/2) and the second set of wavelength-selective ring modulators 107-1 to 107-(N/2) are arranged in the in-line manner, and in which the first bus waveguide 101 and the second bus waveguide 103 are configured to avoid crossing each other, in accordance with some embodiments. In the example of FIG. 5C, the first bus waveguide 101 is configured to extend past and within an evanescent optical coupling distance of the first set of wavelength-selective ring modulators 105-1 to 105-(N/2), and then wrap around the second set of wavelength-selective ring modulators 107-1 to 107-(N/2), such that the first bus waveguide 101 extends past opposite sides of the first set of wavelength-selective ring modulators 105-1 to 105-(N/2) and the second set of wavelength-selective ring modulators 107-1 to 107-(N/2). After passing by the second set of wavelength-selective ring modulators 107-1 to 107-(N/2), the first bus waveguide 101 is routed to optically connect with the first input (TE input) of the polarization interleaving device 109. The second bus waveguide 103 is configured to extend past and within an evanescent optical coupling distance of the second set of wavelength-selective ring modulators 107-1 to 107-(N/2). In some embodiments, such as shown in FIG. 5C, the second bus waveguide 103 turns to be within the evanescent optical coupling distance of the second set of wavelength-selective ring modulators 107-1 to 107-(N/2), to maintain sufficient spacing from the first bus waveguide 101 so as to avoid optical loss and optical crosstalk issues. After passing by the second set of wavelength-selective ring modulators 107-1 to 107-(N/2), the second bus waveguide 103 is routed to optically connect with the second input (TM input) of the polarization interleaving device 109.

FIG. 5D shows a diagram of the split-bus transmitter (TX) 100 in which the first set of wavelength-selective ring modulators 105-1 to 105-(N/2) and the second set of wavelength-selective ring modulators 107-1 to 107-(N/2) are arranged in two separate rows, respectively, in accordance with some embodiments. The split-bus transmitter (TX) 100 configuration of FIG. 5D is referred to as a dual-row configuration. The first set of wavelength-selective ring modulators 105-1 to 105-(N/2) are arranged in a first row. The first bus waveguide 101 extends past and within an evanescent optical coupling distance of the first set of wavelength-selective ring modulators 105-1 to 105-(N/2). After passing by the first set of wavelength-selective ring modulators 105-1 to 105-(N/2), the first bus waveguide 101 is routed to optically connect with the first input (TE input) of the polarization interleaving device 109. The second set of wavelength-selective ring modulators 107-1 to 107-(N/2) are arranged in a second row. The second bus waveguide 103 extends past and within an evanescent optical coupling distance of the second set of wavelength-selective ring modulators 107-1 to 107-(N/2). After passing by the second set of wavelength-selective ring modulators 107-1 to 107-(N/2), the second bus waveguide 103 is routed to optically connect with the second input (TM input) of the polarization interleaving device 109. In the split-bus transmitter (TX) 100 configuration of FIG. 5D, respective ones of the first set of wavelength-selective ring modulators 105-1 to 105-(N/2) and the second set of wavelength-selective ring modulators 107-1 to 107-(N/2) are positioned in substantial vertically alignment with each other. FIG. 5E shows a variation of the split-bus transmitter (TX) 100 configuration of FIG. 5D, in which respective ones of the first set of wavelength-selective ring modulators 105-1 to 105-(N/2) and the second set of wavelength-selective ring modulators 107-1 to 107-(N/2) are positioned in a horizontally staggered manner so as to not be vertically aligned with each other, in accordance with some embodiments.

It should be understood that the various split-bus transmitter (TX) 100 configurations of FIGS. 5A through 5E are provided by way of example. In other embodiments, the split-bus transmitter (TX) 100 can be configured in various other ways as required to accommodate/satisfy chip floor-planning and/or routing requirements and/or other chip design constraints. In some embodiments, the first bus waveguide 101 and the second bus waveguide 103 have substantially uniform configurations. In some embodiments, the first bus waveguide 101 and the second bus waveguide 103 have different configurations as needed to accommodate a particular implementation of the split-bus transmitter (TX) 100. In some instantiations, each of the first bus waveguide 101 and the second bus waveguide 103 is configured as a low optical loss and low non-linear optical loss waveguide, such as silicon nitride or non-linear mitigated silicon rib waveguide.

In some embodiments, each of the first bus waveguide 101 and the second bus waveguide 103 includes multiple waveguide configurations. For example, in some embodiments, the first bus waveguide 101 has a first configuration as it approaches the coupling region with the first set of wavelength-selective ring modulators 105-1 to 105-(N/2), and then has a second configuration as it extends past the first set of wavelength-selective ring modulators 105-1 to 105-(N/2), and then has a third configuration after the first set of wavelength-selective ring modulators 105-1 to 105-(N/2) as it approaches the polarization interleaving device 109. Similarly, in some embodiments, the second bus waveguide 103 has a first configuration as it approaches the coupling region with the second set of wavelength-selective ring modulators 107-1 to 107-(N/2), and then has a second configuration as it extends past the second set of wavelength-selective ring modulators 107-1 to 107-(N/2), and then has a third configuration after the second set of wavelength-selective ring modulators 107-1 to 107-(N/2) as it approaches the polarization interleaving device 109. In some embodiments, optical waveguide tapers are implemented to convert/transition between different waveguide configurations within each of the first bus waveguide 101 and the second bus waveguide 103, such that proper optical coupling is achieved with the first set of wavelength-selective ring modulators 105-1 to 105-(N/2) and the second set of wavelength-selective ring modulators 107-1 to 107-(N/2), respectively. In some embodiments, each of the first bus waveguide 101 and the second bus waveguide 103 is formed by low-loss, low-nonlinear-loss silicon nitride in regions outside of the “modulator area” in order to minimize optical loss and non-linear impairments. Also, in these embodiments, each of the first bus waveguide 101 and the second bus waveguide 103 is formed to taper into non-linear-mitigated silicon waveguide into and out of the “modulator area” in order to minimize the number of waveguide tapers and the optical loss caused by the waveguide tapers. The “modulator area” in these embodiments refers to the physical region in which light conveyed through the first bus waveguide 101 optically couples into the first set of wavelength-selective ring modulators 105-1 to 105-(N/2), and in which light conveyed through the second bus waveguide 103 optically couples into the second set of wavelength-selective ring modulators 107-1 to 107-(N/2).

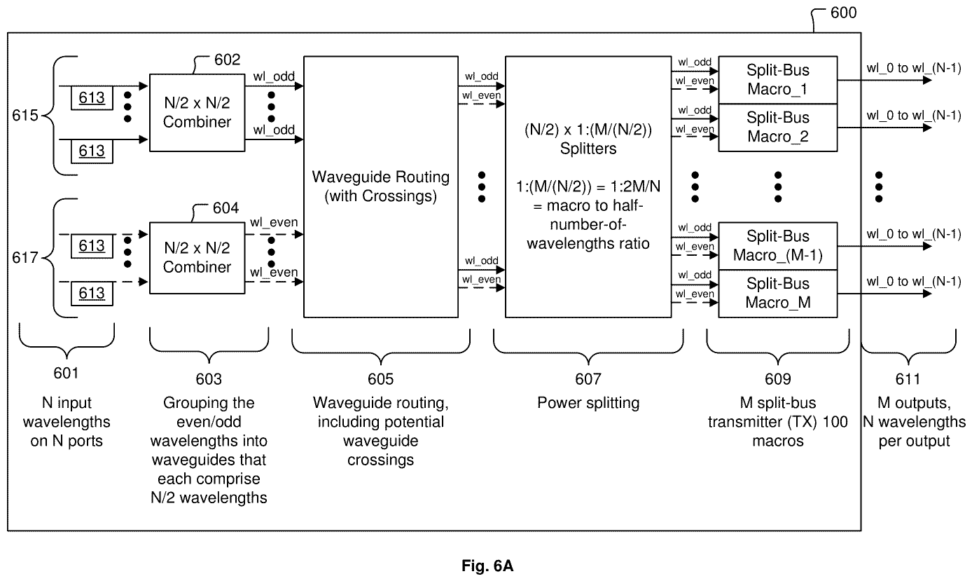

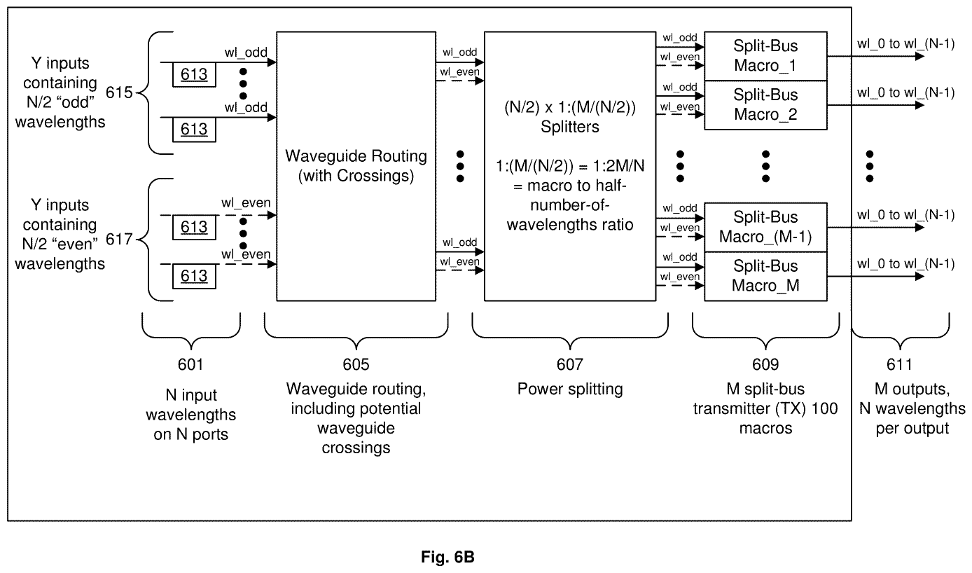

FIG. 6A shows a portion of an example architecture of a chip 600 implementing the split-bus transmitter (TX) 100, in accordance with some embodiments. The chip 600 includes an input stage 601 in which each of the N wavelengths (wl_0 to wl_(N−1)) of continuous wave laser light is brought onto the chip 600. In some embodiments, each of the N wavelengths of continuous wave laser light is conveyed to the chip 600 by a respective optical fiber and is received into the chip 600 by a respective optical fiber coupler, such as a optical grating coupler, edge coupler, or other optical fiber-to-chip optical coupling technique. In some embodiments, an optical combining stage 603 is implemented to provide for grouping of N wavelengths of incoming laser light into a first group 615 of N/2 odd-indexed wavelengths (wl_1, wl_3, . . . wl_(N−1)) and a second group 617 of N/2 even-indexed wavelengths (wl_0, wl_2, . . . wl_(N−2)). In some embodiments, an N/2×N/2 (or other output ratio) optical combiner 602 is implemented to optically combine the odd-indexed wavelengths (wl_1, wl_3, . . . wl_(N−1)) into a number of optical waveguides that each convey the N/2 odd-indexed wavelengths (wl_1, wl_3, . . . wl_(N−1)). Also, in the embodiments, an N/2×N/2 (or other output ratio) optical combiner 604 is implemented to optically combine the even-indexed wavelengths (wl_0, wl_2, . . . wl_(N−2)) into a number of optical waveguides that each convey the N/2 even-indexed wavelengths (wl_0, wl_2, . . . wl_(N−2)).

In some embodiments, the chip 600 includes a routing stage 605 that includes waveguide routings and waveguide crossings, as needed, to achieve a required physical and optical arrangement of optical waveguides on the chip 600. In some embodiments, “dummy” (not used) optical waveguide crossings are added, as needed, to optical conveyance paths that do not otherwise require an optical waveguide crossing in order to balance out optical loss caused by other optical waveguide crossings that are required and used. In some embodiments, the chip 600 includes a power splitting stage 607 that follows the routing stage 605. Based on a number M of the split-bus transmitter (TX) 100 macros and the number N of wavelengths, a number of optical splitters are implemented to provide for optical power splitting to convey sufficient optical power to each of 2*M optical waveguides. The 2*M optical waveguides are grouped into M pairs of optical waveguides, where each of the M pairs of optical waveguide includes one optical waveguide that conveys the N/2 odd-indexed wavelengths (wl_1, wl_3, . . . wl_(N−1)) of continuous wave laser light, and another optical waveguide that conveys the N/2 even-indexed wavelengths (wl_0, wl_2, . . . wl_(N−2)) of continuous wave laser light. The M pairs of optical waveguides are routed from the power splitting stage 607 to M split-bus transmitter (TX) 100 macros, respectively, within a transmitter (TX) stage 609.

The transmitter (TX) state 609 includes M split-bus transmitter (TX) 100 macros, each of which includes the first bus waveguide 101 and the second bus waveguide 103. The first bus waveguide 101 of each one of the M split-bus transmitter (TX) 100 macros receives the even-indexed wavelengths (wl_0, wl_2, . . . wl_(N−2)) of continuous wave laser light from the power splitting stage 607. The second bus waveguide 103 of each one of the M split-bus transmitter (TX) 100 macros receives the odd-indexed wavelengths (wl_1, wl_3, . . . wl_(N−1)) of continuous wave laser light from the power splitting stage 607. Each of the M split-bus transmitter (TX) 100 macros has a single output waveguide through which is conveyed modulated optical signals of all N wavelengths, where the modulated optical signals of the even-indexed wavelengths (wl_0, wl_2, . . . wl_(N−2)) have a first polarization state, and where the modulated optical signals of the odd-indexed wavelengths (wl_1, wl_3, . . . wl_(N−1)) have a second polarization state that is orthogonal to the first polarization state. In some embodiments, the M optical outputs of the M split-bus transmitter (TX) 100 macros are routed as M N-wavelength optical waveguides supporting both orthogonal polarizations to polarization agnostic optical output couplers of the chip 600. In various embodiments, other optical components are included at various stages along the optical train of the chip 600 as shown in FIG. 6A, where the other optical components include one or more of optical waveguide converters, optical waveguide tapers, optical power taps, variable optical attenuators, fixed optical attenuators, and other optical component(s), as needed.

FIG. 6B shows a variation of the example architecture of the chip 600 in which the N wavelengths and corresponding N optical fibers are spatially arranged in the input stage 601 to provide the first group 615 of odd-indexed N/2 wavelengths 615 and the second group of even-indexed N/2 wavelengths, such that the optical combining stage 603 is not required, in accordance with some embodiments. It should be understood that the chip 600 architecture of FIGS. 6A and 6B are shown by way of example. In various embodiments, the particular architecture of the transmitter (TX) chip depends on the configuration and grouping of the N optical input wavelengths, the number N of wavelengths, and the number M of split-bus transmitter (TX) 100 macros. Therefore, it should be appreciated that in various embodiments the particular architecture of the transmitter (TX) chip that implements the split-bus transmitter 100 technology can differ from the examples shown in FIGS. 6A and 6B. Also, the particular splitting and combining ratios depicted in FIGS. 6A and 6B are shown by way of example. In some embodiments, power-of-two optical splitting and optical combining facilitates implementation of photonic devices. However, in some embodiments, other balanced or non-balanced optical splitting and optical combining ratios can be implemented through various optical coupler implementations, such as star couplers, arrayed waveguide gratings (AWGs), Mach-Zehnder interferometers (MZIs), multi-mode interferometers (MMIs), or other optical couplers that are available for use in a photonics architecture. Also, in various embodiments, the groupings and/or arrangements of the N wavelengths of continuous wave light at the input stage 601 can differ from what is shown in FIGS. 6A and 6B. For example, in some embodiments, the grouping of the wavelengths at the input stage 601 is configured such that adjacent even-indexed or odd-indexed wavelengths (e.g., even-1, even-2) are brought in as a pair of wavelengths on a same input channel, followed by the next adjacent pair of even-indexed or odd-indexed wavelengths (e.g., even-3, even-4) on the next input channel, and so on.

In some embodiments, polarization controllers 613 are implemented within the input stage 601, such that light input into the chip 600 does not need to be conveyed to the chip 600 through polarization maintaining fiber. In various embodiments, the polarization controllers 613 are implemented as single-wavelength controllers or as broadband-wavelength controllers, as needed by the architecture of the transmitter (TX). In various embodiments, the polarization controllers 613 include one or more of a variable optical attenuator, an optical coupler, an optical power tap, control logic (analog and/or digital), and some number of stages/arrangements of these and other optical components as needed for recombining of both polarizations of input light into a single output waveguide. In various embodiments, each of the polarization controllers 613 is implemented as a general polarization controller, or as a polarization equalizer that functions to divide each input of arbitrary polarization equally between two outputs.

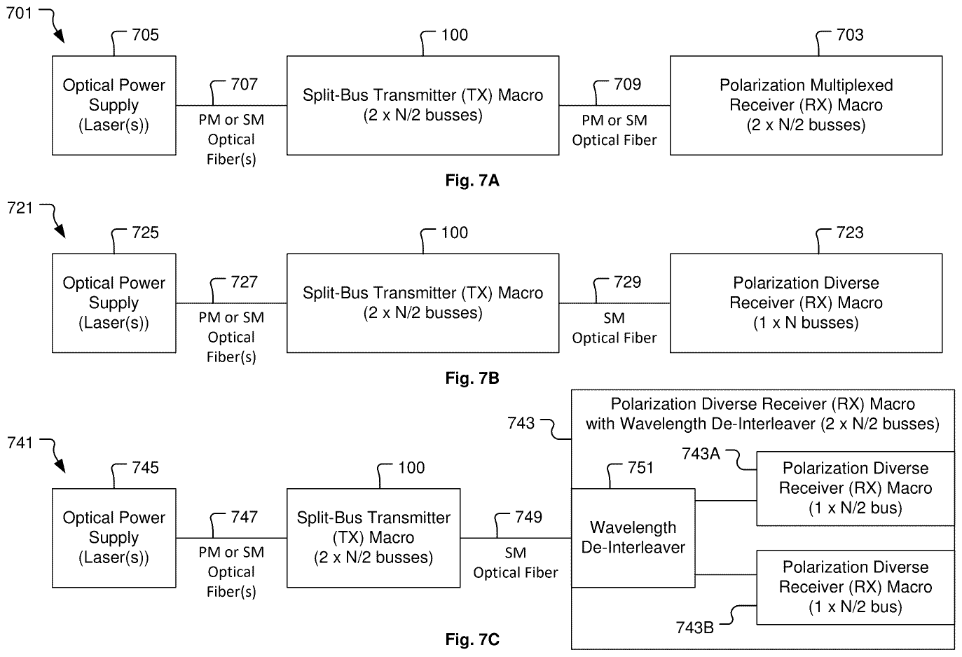

FIG. 7A shows a diagram of the split-bus transmitter (TX) 100 implemented within an optical data communication link 701 that includes a polarization multiplexed receiver (RX) macro 703, in accordance with some embodiments. The optical data communication link 701 is a polarization maintaining link. The optical data communication link 701 includes an optical power supply 705 configured to generate and transmit N wavelengths of continuous wave laser light through optical fiber(s) 707 to the split-bus transmitter (TX) 100. In various embodiments, the optical fiber(s) 707 are either single mode (SM) optical fiber(s) or polarization maintaining (PM) optical fiber(s). The output of the split-bus transmitter (TX) 100 macro is optically connected to the input of the polarization multiplexed receiver (RX) macro 703 through an optical fiber 709. In some embodiments, the optical fiber 709 is a polarization maintaining (PM) optical fiber. In some embodiments, the optical fiber 709 is a single mode (SM) optical fiber. Modulated optical signals of all N wavelengths are conveyed from the output of the split-bus transmitter (TX) 100 macro through the optical fiber 709 to the input of the polarization multiplexed receiver (RX) macro 703, where the modulated optical signals of the even-indexed wavelengths (wl_0, wl_2, . . . wl_(N−2)) have a first polarization state, and where the modulated optical signals of the odd-indexed wavelengths (wl_1, wl_3, . . . wl_(N−1)) have a second polarization state that is orthogonal to the first polarization state.

In some embodiments, the split-bus transmitter (TX) 100 is used to reduce optical power loss, reduce non-linear optical impairments, and/or reduce optical crosstalk in the polarization maintaining link. In various embodiments, the output of the split-bus transmitter (TX) 100 is carried by either PM or SM optical fiber 709, as the system requires, to the polarization multiplexed receiver (RX) macro 703, which is configured to separate the two orthogonal polarization signal sets (TE set and TM set) and recover each of the N wavelength channels. In some embodiments, the polarization multiplexed receiver (RX) macro 703 includes digital signal processing, optical techniques, and/or other techniques to perform the polarization separation and wavelength channel recovery. Also, in some embodiments, the polarization multiplexed receiver (RX) macro 703 is configured to recover the N optical channels in a manner that involves optical separation of the N/2 even-indexed wavelength (wl_0, wl_2, . . . wl_(N−2)) channel groups and the N/2 odd-indexed wavelength (wl_1, wl_3, . . . wl_(N−1)) channel groups before further signal processing.

FIG. 7B shows a diagram of the split-bus transmitter (TX) 100 implemented within an optical data communication link 721 that includes a polarization diverse receiver (RX) macro 723, in accordance with some embodiments. The optical data communication link 721 is a polarization diverse link. The optical data communication link 721 includes an optical power supply 725 configured to generate and transmit N wavelengths of continuous wave laser light through optical fiber(s) 727 to the split-bus transmitter (TX) 100. In various embodiments, the optical fiber(s) 727 are either SM or PM optical fiber(s). The output of the split-bus transmitter (TX) 100 macro is optically connected to the input of the polarization diverse receiver (RX) macro 723 through an SM optical fiber 729. Modulated optical signals of all N wavelengths are conveyed from the output of the split-bus transmitter (TX) 100 macro through the SM optical fiber 729 to the input of the polarization diverse receiver (RX) macro 723, where the modulated optical signals of the even-indexed wavelengths (wl_0, wl_2, . . . wl_(N−2)) have a first polarization state, and where the modulated optical signals of the odd-indexed wavelengths (wl_1, wl_3, . . . wl_(N−1)) have a second polarization state that is orthogonal to the first polarization state. In some embodiments, the polarization diverse receiver (RX) macro 723 is configured to recover the N optical channels in a manner that does not involve optical separation of the N/2 even-indexed wavelength (wl_0, wl_2, . . . wl_(N−2)) channel groups and the N/2 odd-indexed wavelength (wl_1, wl_3, . . . wl_(N−1)) channel groups before further signal processing.

It should be appreciated that the optical data communication link 721 that incorporates the split-bus transmitter (TX) 100 macro can differ from the polarization multiplexed optical data communication link 701. For example, in the optical data communication link 721 that incorporates the split-bus transmitter (TX) 100 macro and the polarization diverse receiver (RX) macro 723, the polarization diverse receiver (RX) macro 723 does not need to be capable of separating modulated signals of different polarizations, unless they are otherwise separable, such as by temporal spacing and/or by wavelength. For example, in the optical data communication link 721, the split-bus transmitter (TX) 100 macro is configured to modulate N wavelengths having a wavelength separation of DELTA_WL, and the polarization diverse receiver (RX) macro 723 is configured to separate signals that have the wavelength separation of DELTA_WL or larger, even though the polarization diverse receiver (RX) macro 723 does not have intrinsic polarization-resolving capability. The optical data communication link 721 is different than the optical data communication link 701 in that, unlike the polarization multiplexed receiver (RX) macro 703, the polarization diverse receiver (RX) macro 723 does not extract two separate data streams on the basis of polarization, but rather separates the data streams based on wavelength. In some embodiments, other optical techniques, such as higher order optical filtering, among others, are implemented as needed by the system architecture in the receiver (RX) device.

FIG. 7C shows a diagram of the split-bus transmitter (TX) 100 implemented within an optical data communication link 741 that includes a wavelength de-interleaver 751 as a pre-stage to a pair of polarization diverse receiver (RX) macros 743A, 743B, in accordance with some embodiments. The wavelength de-interleaver 751 and the pair of polarization diverse receiver (RX) macros 743A, 743B collectively form a receiver (RX) macro 743. The optical data communication link 741 is a polarization diverse link. The optical data communication link 741 includes an optical power supply 745 configured to generate and transmit N wavelengths of continuous wave laser light through optical fiber(s) 747 to the split-bus transmitter (TX) 100. In various embodiments, the optical fiber(s) 747 are either SM or PM optical fiber(s). The output of the split-bus transmitter (TX) 100 macro is optically connected to the input of the wavelength de-interleaver 751 through an SM optical fiber 749. Modulated optical signals of all N wavelengths are conveyed from the output of the split-bus transmitter (TX) 100 macro through the SM optical fiber 749 to the input of the wavelength de-interleaver 751, where the modulated optical signals of the even-indexed wavelengths (wl_0, wl_2, . . . wl_(N−2)) have a first polarization state, and where the modulated optical signals of the odd-indexed wavelengths (wl_1, wl_3, . . . wl_(N−1)) have a second polarization state that is orthogonal to the first polarization state.

The wavelength de-interleaver 751 is configured to separate the incoming modulated optical signals received from the split-bus transmitter (TX) 100 based on wavelength, and direct the incoming N/2 modulated signals that have even-indexed wavelengths (wl_0, wl_2, . . . wl_(N−2)) and arbitrary polarization state to a first 1×N/2 polarization diverse receiver (RX) macro 743A, and direct the incoming N/2 modulated signals that have odd-indexed wavelengths (wl_1, wl_3, . . . wl_(N−1)) and arbitrary polarization state to a second 1×N/2 polarization diverse receiver (RX) macro 743B. Each of the first 1×N/2 polarization diverse receiver (RX) macro 743A and the second 1×N/2 polarization diverse receiver (RX) macro 743B is configured to recover the respectively received N/2 optical channels in a manner that does not involve discernment of polarization state. In some embodiments, each of the first 1×N/2 polarization diverse receiver (RX) macro 743 and the second 1×N/2 polarization diverse receiver (RX) macro 743B is configured to separate signals that have the wavelength separation of DELTA_WL or larger, where the split-bus transmitter (TX) 100 macro is configured to modulate N wavelengths having the wavelength separation of DELTA_WL.

The various embodiments of the split-bus transmitter (TX) 100 disclosed herein provide a transmitter for an optical data communication system. The transmitter includes the first bus waveguide 101, the first set of wavelength-selective ring modulators 105-1 to 105-(N/2), the second bus waveguide 103, the second set of wavelength-selective ring modulators 107-1 to 107-(N/2), the polarization interleaving device 109, and the output waveguide 111. The first set of wavelength-selective ring modulators 105-1 to 105-(N/2) are positioned along the first bus waveguide 101 and within an evanescent optical coupling distance of the first bus waveguide 101. The first set of wavelength-selective ring modulators 105-1 to 105-(N/2) are configured to modulate optical signals conveyed through the first bus waveguide 101 to generate a first set of modulated optical signals within the first bus waveguide 101. The second set of wavelength-selective ring modulators 107-1 to 107-(N/2) are positioned along the second bus waveguide 103 and within an evanescent optical coupling distance of the second bus waveguide 103. The second set of wavelength-selective ring modulators 107-1 to 107-(N/2) are configured to modulate optical signals conveyed through the second bus waveguide 103 to generate a second set of modulated optical signals within the second bus waveguide 103. In some embodiments, the polarization of the first set of modulated optical signals is TE, and the polarization of the second set of modulated optical signals is TE.

The polarization interleaving device 109 has a first input optically connected to the first bus waveguide 101 and a second input optically connected to the second bus waveguide 103. The polarization interleaving device 109 is configured to rotate a polarization of the first set of modulated optical signals received at the first input to a first polarization state to form a first set of output signals. The polarization interleaving device 109 is also configured to rotate a polarization of the second set of modulated optical signals received at the second input to a second polarization state to form a second set of output signals. The second polarization state is orthogonal to the first polarization state. In some embodiments, the first polarization state is the TE polarization state, and the second polarization state is the TM polarization state. In some embodiments, the first polarization state is the TM polarization state, and the second polarization state is the TE polarization state. The polarization interleaving device 109 is also configured to combine the first set of output signals and the second set of output signals onto the output waveguide 111. In some embodiments, the polarization interleaving device 109 is implemented using a polarization splitter rotator device. In some embodiments, the polarization interleaving device 109 is implemented using a dual-polarization grating coupler.

The first bus waveguide 101 has the input end 101i and the output end 1010. The input end 101i of the first bus waveguide 101 is connected to receive a first set of wavelengths of continuous wave laser light. The output end 1010 of the first bus waveguide 101 is connected to the first input of the polarization interleaving device 109. The second bus waveguide 103 has the input end 103i and an output end 1030. The input end 103i of the second bus waveguide 103 is connected to receive a second set of wavelengths of continuous wave laser light. The output end 1030 of the second bus waveguide 103 is connected to the second input of the polarization interleaving device 109. The second set of wavelengths are mutually exclusive of the first set of wavelengths.

In some embodiments, the first set of wavelengths includes one-half of a total number N of wavelengths, and the second set of wavelengths includes one-half of the total number N of wavelengths. In some embodiments, adjacent ones of the first set of wavelengths have a wavelength spacing of two times a channel-to-channel wavelength spacing, and adjacent ones of the second set of wavelengths also have the wavelength spacing of two times the channel-to-channel wavelength spacing, and each one of the second set of wavelengths that is located between a respective adjacent pair of wavelengths within the first set of wavelengths is centered between the respective adjacent pair of wavelengths.

In some embodiments, a number of ring modulators in the first set of wavelength-selective ring modulators 105-1 to 105-(N/2) is equal to one-half of the total number N of wavelengths, and a number of ring modulators in the second set of wavelength-selective ring modulators 107-1 to 107-(N/2) is also equal to one-half of the total number N of wavelengths. The first set of wavelength-selective ring modulators 105-1 to 105-(N/2) have resonance wavelengths respectively corresponding to the first set of wavelengths, and the second set of wavelength-selective ring modulators 107-1 to 107-(N2) have resonance wavelengths respectively corresponding to the second set of wavelengths.

In some embodiments, the transmitter includes the output coupler 112 to which the output waveguide 111 is optically connected. In some embodiments, the first set of wavelength-selective ring modulators 105-1 to 105-(N/2) and the second set of wavelength-selective ring modulators 107-1 to 107-(N/2) are arranged in a substantially linear manner. In some embodiments, the first bus waveguide 101 and the second bus waveguide 103 cross each other to enable evanescent optical coupling between the first bus waveguide 101 and the first set of wavelength-selective ring modulators 105-1 to 105-(N/2), and to enable evanescent optical coupling between the second bus waveguide 103 and the second set of wavelength-selective ring modulators 107-1 to 107-(N/2). In some embodiments, the first bus waveguide 101 curves to pass between the first set of wavelength-selective ring modulators 105-1 to 105-(N/2) and the second set of wavelength-selective ring modulators 107-1 to 107-(N/2) to enable evanescent optical coupling between the second bus waveguide 103 and the second set of wavelength-selective ring modulators 107-1 to 107-(N/2) without the first bus waveguide 101 and the second bus waveguide 103 crossing each other. In some embodiments, the first set of wavelength-selective ring modulators 105-1 to 105-(N/2) are arranged in a substantially linear manner in a first row, and the second set of wavelength-selective ring modulators 107-1 to 107-(N/2) are arranged in a substantially linear manner in a second row, where the first bus waveguide 101 extends between the first row and the second row.

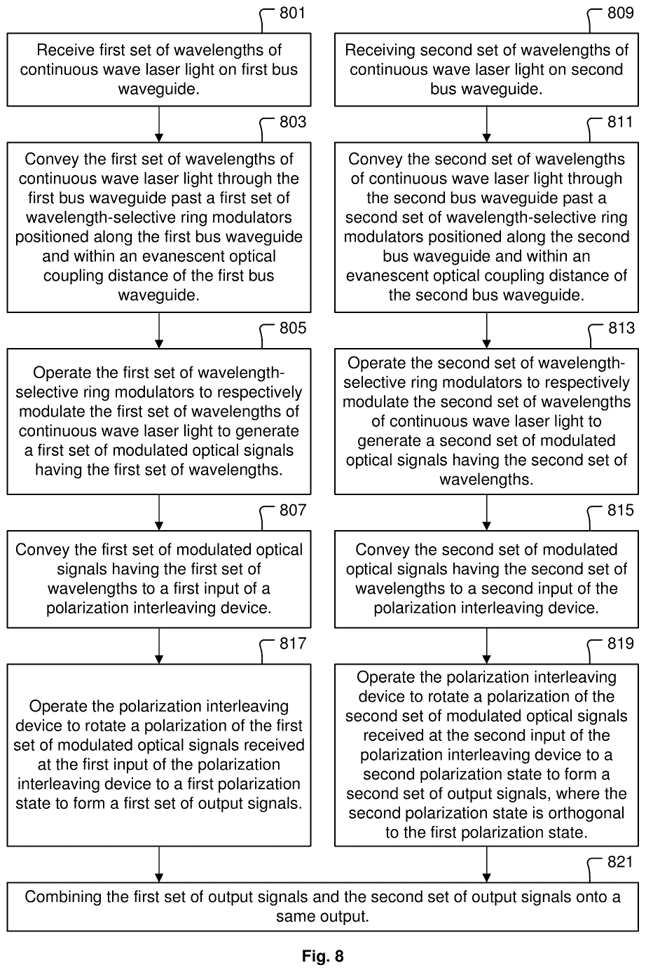

FIG. 8 shows a flowchart of a method for operating a transmitter (the split-bus transmitter (TX) 100) within an optical data communication system, in accordance with some embodiments. The method includes an operation 801 for receiving a first set of wavelengths of continuous wave laser light on the first bus waveguide 101. The method also includes an operation 803 for conveying the first set of wavelengths of continuous wave laser light through the first bus waveguide 101 past the first set of wavelength-selective ring modulators 105-1 to 105-(N/2) positioned along the first bus waveguide 101 and within an evanescent optical coupling distance of the first bus waveguide 101. The method also includes an operation 805 for operating the first set of wavelength-selective ring modulators 105-1 to 105-(N/2) to respectively modulate the first set of wavelengths of continuous wave laser light to generate a first set of modulated optical signals having the first set of wavelengths. The method also includes an operation 807 for conveying the first set of modulated optical signals having the first set of wavelengths to a first input of the polarization interleaving device 109. The method also includes an operation 809 for receiving a second set of wavelengths of continuous wave laser light on the second bus waveguide 103. The method also includes an operation 811 for conveying the second set of wavelengths of continuous wave laser light through the second bus waveguide 103 past the second set of wavelength-selective ring modulators 107-1 to 107-(N/2) positioned along the second bus waveguide 103 and within an evanescent optical coupling distance of the second bus waveguide 103. The method also includes an operation 813 for operating the second set of wavelength-selective ring modulators 107-1 to 107-(N/2) to respectively modulate the second set of wavelengths of continuous wave laser light to generate a second set of modulated optical signals having the second set of wavelengths. The method also includes an operation 815 for conveying the second set of modulated optical signals having the second set of wavelengths to a second input of the polarization interleaving device 109. The method also includes an operation 817 for operating the polarization interleaving device 109 to rotate a polarization of the first set of modulated optical signals received at the first input of the polarization interleaving device 109 to a first polarization state to form a first set of output signals. The method also includes an operation 819 for operating the polarization interleaving device 109 to rotate a polarization of the second set of modulated optical signals received at the second input of the polarization interleaving device 109 to a second polarization state to form a second set of output signals, where the second polarization state is orthogonal to the first polarization state. The method also includes an operation 821 for combining the first set of output signals and the second set of output signals onto a same output. In some embodiments, the first set of output signals and the second set of output signals are combined onto a same output waveguide, e.g., 111 or 114. In some embodiments, the first set of output signals and the second set of output signals are projected in a same light beam for optical reception by another photonic device.

The second set of wavelengths are mutually exclusive of the first set of wavelengths. In some embodiments, the first set of wavelengths includes one-half of a total number N of wavelengths, and the second set of wavelengths includes one-half of the total number N of wavelengths. In some embodiments, adjacent ones of the first set of wavelengths have a wavelength spacing of two times a channel-to-channel wavelength spacing, and adjacent ones of the second set of wavelengths also have the wavelength spacing of two times the channel-to-channel wavelength spacing. Also, in these embodiments, each one of the second set of wavelengths that is located between a respective adjacent pair of wavelengths within the first set of wavelengths is centered between a respective adjacent pair of wavelengths. In some embodiments, the first polarization state is a transverse electric (TE) polarization state, and the second polarization state is a transverse magnetic (TM) polarization state. In some embodiments, the first set of wavelengths of continuous wave laser light has a TE polarization state, and the second set of wavelengths of continuous wave laser light also has the TE polarization state.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other operations may be performed in between method operations, and/or method operations may be adjusted so that they occur at slightly different times or simultaneously, or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. A transmitter for an optical data communication system, comprising:
a first bus waveguide;
a first set of wavelength-selective ring modulators positioned along the first bus waveguide and within an evanescent optical coupling distance of the first bus waveguide, the first set of wavelength-selective ring modulators configured to modulate optical signals conveyed through the first bus waveguide to generate a first set of modulated optical signals within the first bus waveguide;
a second bus waveguide;
a second set of wavelength-selective ring modulators positioned along the second bus waveguide and within an evanescent optical coupling distance of the second bus waveguide, the second set of wavelength-selective ring modulators configured to modulate optical signals conveyed through the second bus waveguide to generate a second set of modulated optical signals within the second bus waveguide; and
a polarization interleaving device having a first input optically connected to the first bus waveguide and a second input optically connected to the second bus waveguide, the polarization interleaving device configured to rotate a polarization of the first set of modulated optical signals received at the first input to a first polarization state to form a first set of output signals, the polarization interleaving device configured to rotate a polarization of the second set of modulated optical signals received at the second input to a second polarization state to form a second set of output signals, the second polarization state being orthogonal to the first polarization state, the polarization interleaving device configured to combine the first set of output signals and the second set of output signals onto an output of the transmitter.

2. The transmitter for the optical data communication system as recited in claim 1, wherein the first bus waveguide has an input end and an output end, the input end of the first bus waveguide connected to receive a first set of wavelengths of continuous wave laser light, the output end of the first bus waveguide connected to the first input of the polarization interleaving device,
wherein the second bus waveguide has an input end and an output end, the input end of the second bus waveguide connected to receive a second set of wavelengths of continuous wave laser light, the output end of the second bus waveguide connected to the second input of the polarization interleaving device, and
wherein the second set of wavelengths are mutually exclusive of the first set of wavelengths.

3. The transmitter for the optical data communication system as recited in claim 2, wherein the first set of wavelengths includes one-half of a total number of wavelengths, and wherein the second set of wavelengths includes one-half of the total number of wavelengths.

4. The transmitter for the optical data communication system as recited in claim 3, wherein adjacent ones of the first set of wavelengths have a wavelength spacing of two times a channel-to-channel wavelength spacing, wherein adjacent ones of the second set of wavelengths also have the wavelength spacing of two times the channel-to-channel wavelength spacing, and wherein each one of the second set of wavelengths that is located between a respective adjacent pair of wavelengths within the first set of wavelengths is centered between the respective adjacent pair of wavelengths.

5. The transmitter for the optical data communication system as recited in as recited in claim 4, wherein a number of ring modulators in the first set of wavelength-selective ring modulators is equal to one-half of the total number of wavelengths, and wherein a number of ring modulators in the second set of wavelength-selective ring modulators is also equal to one-half of the total number of wavelengths.

6. The transmitter for the optical data communication system as recited in as recited in claim 5, wherein the first set of wavelength-selective ring modulators have resonance wavelengths respectively corresponding to the first set of wavelengths, and wherein the second set of wavelength-selective ring modulators have resonance wavelengths respectively corresponding to the second set of wavelengths.

7. The transmitter for the optical data communication system as recited in as recited in claim 6, wherein the first polarization state is a transverse electric (TE) polarization state, and wherein the second polarization state is a transverse magnetic (TM) polarization state.

8. The transmitter for the optical data communication system as recited in as recited in claim 7, wherein the polarization of the first set of modulated optical signals is TE, and wherein the polarization of the second set of modulated optical signals is TE.

9. The transmitter for the optical data communication system as recited in claim 1, wherein the polarization interleaving device is implemented using a polarization splitter rotator device.

10. The transmitter for the optical data communication system as recited in claim 1, wherein the polarization interleaving device is implemented using a dual-polarization grating coupler.

11. The transmitter for the optical data communication system as recited in claim 1, further comprising:
an output coupler optically connected to the output of the transmitter.

12. The transmitter for the optical data communication system as recited in claim 1, wherein the first set of wavelength-selective ring modulators and the second set of wavelength-selective ring modulators are arranged in a substantially linear manner.

13. The transmitter for the optical data communication system as recited in claim 12, wherein the first bus waveguide and the second bus waveguide cross each other to enable evanescent optical coupling between the first bus waveguide and the first set of wavelength-selective ring modulators and to enable evanescent optical coupling between the second bus waveguide and the second set of wavelength-selective ring modulators.

14. The transmitter for the optical data communication system as recited in claim 12, wherein the first bus waveguide curves to pass between the first set of wavelength-selective ring modulators and the second set of wavelength-selective ring modulators to enable evanescent optical coupling between the second bus waveguide and the second set of wavelength-selective ring modulators without the first bus waveguide and the second bus waveguide crossing each other.

15. The transmitter for the optical data communication system as recited in claim 1, wherein the first set of wavelength-selective ring modulators are arranged in a substantially linear manner in a first row, and wherein the second set of wavelength-selective ring modulators are arranged in a substantially linear manner in a second row, wherein the first bus waveguide extends between the first row and the second row.

16. A method for operating a transmitter within an optical data communication system, comprising:
receiving a first set of wavelengths of continuous wave laser light on a first bus waveguide;
conveying the first set of wavelengths of continuous wave laser light through the first bus waveguide past a first set of wavelength-selective ring modulators positioned along the first bus waveguide and within an evanescent optical coupling distance of the first bus waveguide;
operating the first set of wavelength-selective ring modulators to respectively modulate the first set of wavelengths of continuous wave laser light to generate a first set of modulated optical signals having the first set of wavelengths;
conveying the first set of modulated optical signals having the first set of wavelengths to a first input of a polarization interleaving device;
receiving a second set of wavelengths of continuous wave laser light on a second bus waveguide;
conveying the second set of wavelengths of continuous wave laser light through the second bus waveguide past a second set of wavelength-selective ring modulators positioned along the second bus waveguide and within an evanescent optical coupling distance of the second bus waveguide;
operating the second set of wavelength-selective ring modulators to respectively modulate the second set of wavelengths of continuous wave laser light to generate a second set of modulated optical signals having the second set of wavelengths;
conveying the second set of modulated optical signals having the second set of wavelengths to a second input of the polarization interleaving device;
operating the polarization interleaving device to rotate a polarization of the first set of modulated optical signals received at the first input of the polarization interleaving device to a first polarization state to form a first set of output signals;
operating the polarization interleaving device to rotate a polarization of the second set of modulated optical signals received at the second input of the polarization interleaving device to a second polarization state to form a second set of output signals, the second polarization state being orthogonal to the first polarization state; and
combining the first set of output signals and the second set of output signals onto a same output.

17. The method as recited in claim 16, wherein the second set of wavelengths are mutually exclusive of the first set of wavelengths, wherein the first set of wavelengths includes one-half of a total number of wavelengths, wherein the second set of wavelengths includes one-half of the total number of wavelengths.

18. The method as recited in claim 17, wherein adjacent ones of the first set of wavelengths have a wavelength spacing of two times a channel-to-channel wavelength spacing, wherein adjacent ones of the second set of wavelengths also have the wavelength spacing of two times the channel-to-channel wavelength spacing, and wherein each one of the second set of wavelengths that is located between a respective adjacent pair of wavelengths within the first set of wavelengths is centered between the respective adjacent pair of wavelengths.

19. The method as recited in claim 18, wherein the first polarization state is a transverse electric (TE) polarization state, and wherein the second polarization state is a transverse magnetic (TM) polarization state.

20. The method as recited in claim 19, wherein the first set of wavelengths of continuous wave laser light has a TE polarization state, and wherein the second set of wavelengths of continuous wave laser light also has the TE polarization state.
